(19) United States
(12) Patent Application Publication
(10) Pub. No.: US 2025/0372310 A1
(43) Pub. Date: Dec. 4, 2025

(54) MULTILAYER CERAMIC CAPACITOR

(71) Applicant: Murata Manufacturing Co., Ltd., Nagaokakyo-shi (JP)

(72) Inventor: Ken TOMINAGA, Nagaokakyo-shi (JP)

(21) Appl. No.: 19/297,047

(22) Filed: Aug. 12, 2025

Related U.S. Application Data
(63) Continuation of application No. PCT/JP2024/001186, filed on Jan. 18, 2024.

(30) Foreign Application Priority Data
Apr. 28, 2023 (JP) 2023-074080

(51) Int. Cl. H01G 4/30; H01G 4/232

(52) U.S. Cl. CPC H01G 4/30; H01G 4/232

(57) ABSTRACT

A multilayer ceramic capacitor includes a multilayer body including laminated dielectric layers, first and second main surfaces, first and second side surfaces, first and second end surfaces, and first and second internal electrode layers laminated alternately with the plurality of dielectric layers and respectively exposed on the first and second end surfaces, a first outer electrode covering portions of the first end surface and the first main surface, and a second outer electrode covering portions of the second end surface and the first main surface. The first and second outer electrodes each include a thin film layer, a lower plating layer, an upper plating layer, and a front plating layer. An end edge portion of the thin film layer located adjacent to a center of the multilayer body is spaced apart from the multilayer body.

### CROSS REFERENCE TO RELATED APPLICATIONS

This application claims the benefit of priority to Japanese Patent Application No. 2023-074080 filed on Apr. 28, 2023 and is a Continuation Application of PCT Application No. PCT/JP2024/001186 filed on Jan. 18, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, electronic devices such as mobile phones and portable music players are becoming smaller in size and thickness. Accordingly, multilayer ceramic capacitors mounted in such electronic devices that are small in size and thickness are also becoming smaller in size and thickness.

For example, a multilayer ceramic capacitor whose dimension T in a Z-axis direction (laminating direction) is less than 0.3 mm is known (see, for example, Japanese Unexamined Patent Application Publication No. 2020-136363). The multilayer ceramic capacitor described in Japanese Unexamined Patent Application Publication No. 2020-136363 is configured such that an outer electrode includes a base film made of a sintered metal film and a plating film disposed on the base film.

However, in a multilayer ceramic capacitor such as the one described in Japanese Unexamined Patent Application Publication No. 2020-136363, there arises a situation where an end portion of the base film that is located close to a center of a multilayer body is fixed to the multilayer body and is coated with a plating film. As a result, a crack may undesirably extend from a leading end of the base film to an inside of the multilayer ceramic capacitor due to stress concentration at the base film caused by thermal stress or the like.

### SUMMARY OF THE INVENTION

Example embodiments of the present invention provide multilayer ceramic capacitors in each of which stress applied to an end portion of a thin film layer (base film) is able to be dispersed and thus an extension of a crack to an inside of the multilayer ceramic capacitor is reduced or prevented.

A multilayer ceramic capacitor according to an example embodiment of the present invention includes a multilayer body including a plurality of laminated dielectric layers, a first main surface and a second main surface that are opposed to each other in a laminating direction, a first side surface and a second side surface that are opposed to each other in a width direction orthogonal or substantially orthogonal to the laminating direction, and a first end surface and a second end surface that are opposed to each other in a length direction orthogonal or substantially orthogonal to the laminating direction and the width direction, and including a first internal electrode layer laminated alternately with the plurality of dielectric layers and being exposed on the first end surface, and a second internal electrode layer laminated alternately with the plurality of dielectric layers and being exposed on the second end surface, a first outer electrode covering a portion of the first end surface and a portion of the first main surface of the multilayer body, and a second outer electrode covering a portion of the second end surface and a portion of the first main surface of the multilayer body, in which the first outer electrode and the second outer electrode each include a thin film layer covering at least a portion of the first main surface, a lower plating layer covering at least a portion of the thin film layer, an upper plating layer on the lower plating layer, and a front plating layer on the upper plating layer, and an end edge portion of the thin film layer located adjacent to a center of the multilayer body is spaced apart from the multilayer body on the first main surface.

A multilayer ceramic capacitor according to another example embodiment of the present invention includes a multilayer body including a plurality of laminated dielectric layers, a first main surface and a second main surface that are opposed to each other in a laminating direction, a first side surface and a second side surface that are opposed to each other in a width direction orthogonal or substantially orthogonal to the laminating direction, and a third side surface and a fourth side surface that are opposed to each other in a length direction orthogonal or substantially orthogonal to the laminating direction and the width direction, and including a first internal electrode layer laminated alternately with the plurality of dielectric layers and being exposed at least on the first side surface and the second side surface, and a second internal electrode layer laminated alternately with the plurality of dielectric layers and being exposed at least on the first side surface and the second side surface, a first outer electrode covering a portion of the first side surface and a portion of the first main surface of the multilayer body, a second outer electrode covering a portion of the second side surface and a portion of the first main surface of the multilayer body, a third outer electrode spaced apart from the first outer electrode and covering a portion of the first side surface and a portion of the first main surface of the multilayer body, and a fourth outer electrode spaced apart from the second outer electrode and covering a portion of the second side surface and a portion of the first main surface of the multilayer body, in which the first outer electrode, the second outer electrode, the third outer electrode, and the fourth outer electrode each include a thin film layer covering at least a portion of any one or more surfaces of the multilayer body, a lower plating layer covering at least a portion of the thin film layer, an upper plating layer on the lower plating layer, and a front plating layer on the upper plating layer, and an end edge portion of the thin film layer located adjacent to a center of the multilayer body is spaced apart from the multilayer body.

According to an example embodiment of the present invention, the end edge portion of the thin film layer that is located adjacent to the center of the multilayer body is spaced apart from the multilayer body, and therefore stress applied to the end portion of the thin film layer is able to be dispersed and thus an extension of a crack to an inside of the multilayer ceramic capacitor is reduced or prevented.

According to example embodiments of the present invention, it is possible to provide multilayer ceramic capacitors in each of which stress applied to an end portion (end edge portion) of a thin film layer (base film) is able to be dispersed and thus an extension of a crack to an inside of the multilayer ceramic capacitor is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating a multilayer ceramic capacitor according to a first example embodiment of the present invention.

FIG. 2 is a front view illustrating the multilayer ceramic capacitor according to the first example embodiment of the present invention.

FIG. 3 is a top view illustrating the multilayer ceramic capacitor according to the first example embodiment of the present invention.

FIG. 4 is a cross-sectional view taken along line IV-IV in FIG. 1.

FIG. 5 is a cross-sectional view taken along line V-V in FIG. 1.

FIG. 6 is an enlarged view of an a portion in FIG. 4.

FIG. 7 is an external perspective view of a multilayer ceramic capacitor according to a second example embodiment of the present invention.

FIG. 8 is a front view illustrating the multilayer ceramic capacitor according to the second example embodiment of the present invention.

FIG. 9 is a top view illustrating the multilayer ceramic capacitor according to the second example embodiment of the present invention.

FIG. 10 is a cross-sectional view taken along line X-X in FIG. 7.

FIG. 11 is a cross-sectional view taken along line XI-XI in FIG. 7.

FIG. 12 is an external perspective view illustrating a multilayer ceramic capacitor according to a third example embodiment of the present invention.

FIG. 13 is a cross-sectional view taken along line XIII-XIII in FIG. 12.

FIG. 14 is a cross-sectional view taken along line XIV-XIV in FIG. 12.

FIG. 15 is a cross-sectional view taken along line XV-XV in FIG. 12.

FIG. 16 is a top view illustrating a multilayer body and a thin film layer of the multilayer ceramic capacitor according to the third example embodiment of the present invention.

FIG. 17 is a bottom view illustrating the multilayer body and the thin film layer of the multilayer ceramic capacitor according to the third example embodiment of the present invention.

FIG. 18 is a front view illustrating the multilayer body and the thin film layer of the multilayer ceramic capacitor according to the third example embodiment of the present invention.

FIG. 19 is a back view illustrating the multilayer body and the thin film layer of the multilayer ceramic capacitor according to the third example embodiment of the present invention.

FIG. 20 is a left side view illustrating the multilayer body and the thin film layer of the multilayer ceramic capacitor according to the third example embodiment of the present invention.

FIG. 21 is a right side view illustrating the multilayer body and the thin film layer of the multilayer ceramic capacitor according to the third example embodiment of the present invention.

FIG. 22 is an enlarged view of a β portion in FIG. 13.

FIG. 23 is an exploded perspective view of the multilayer body illustrated in FIG. 12.

FIG. 24 is an external perspective view illustrating a multilayer ceramic capacitor according to a fourth example embodiment of the present invention.

FIG. 25 is a cross-sectional view taken along line XXV-XXV in FIG. 24.

FIG. 26 is a cross-sectional view taken along line XXVI-XXVI in FIG. 24.

FIG. 27 is a cross-sectional view taken along line XXVII-XXVII in FIG. 24.

FIG. 28 is an exploded perspective view of the multilayer body illustrated in FIG. 24.

FIG. 29 is an external perspective view illustrating a multilayer ceramic capacitor according to a fifth example embodiment of the present invention.

FIG. 30 is a bottom view illustrating the multilayer ceramic capacitor according to the fifth example embodiment of the present invention.

FIG. 31 is a cross-sectional view taken along line XXXI-XXXI in FIG. 29.

FIG. 32 is a cross-sectional view taken along line XXXII-XXXII in FIG. 29.

### DETAILED DESCRIPTION OF THE EXAMPLE EMBODIMENTS

Multilayer ceramic capacitors according to example embodiments of the present invention will be described in detail below with reference to the drawings.

### A. First Example Embodiment

### 1. Multilayer Ceramic Capacitor

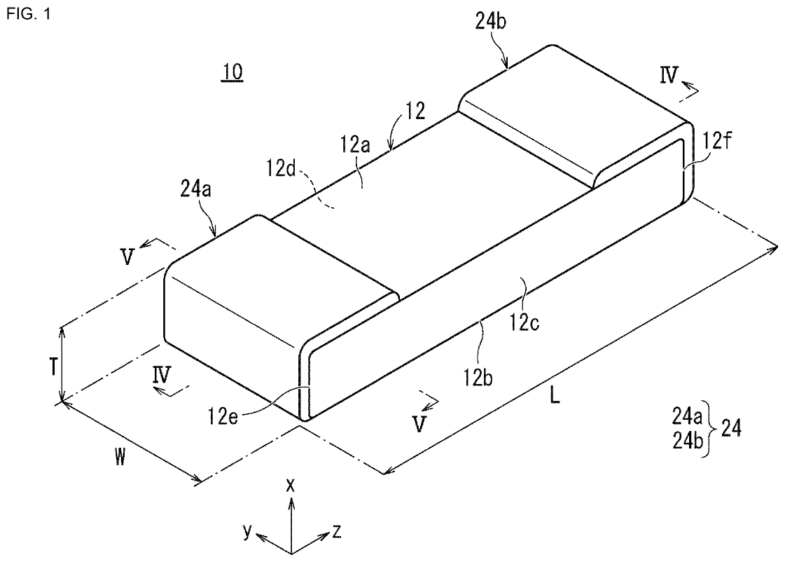

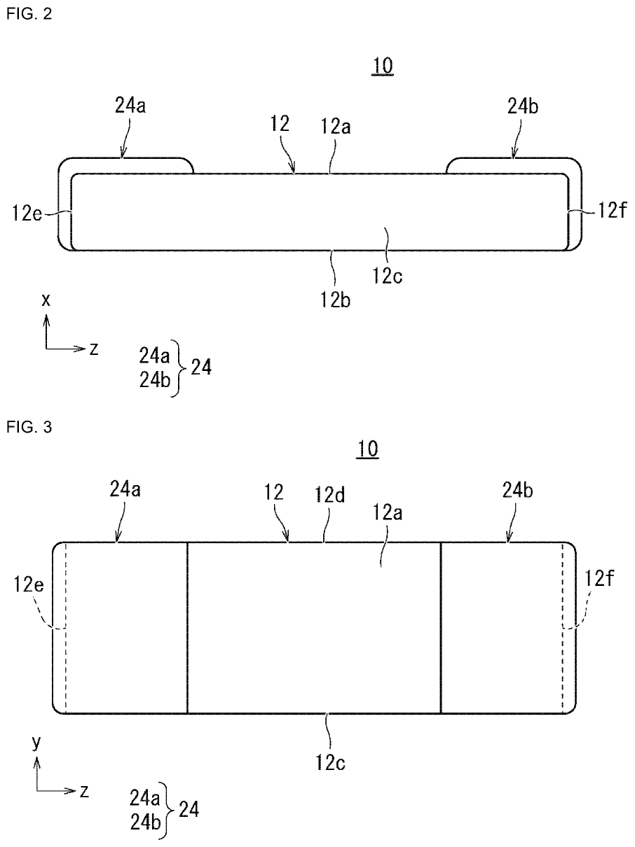

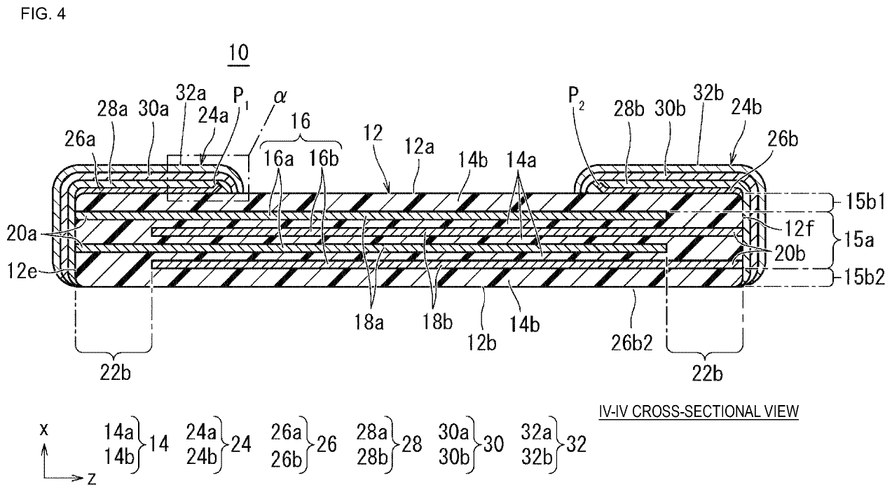

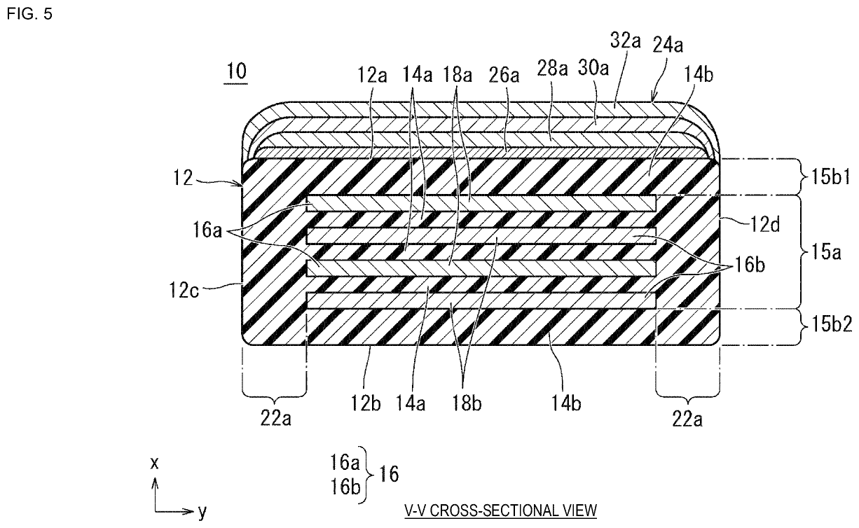

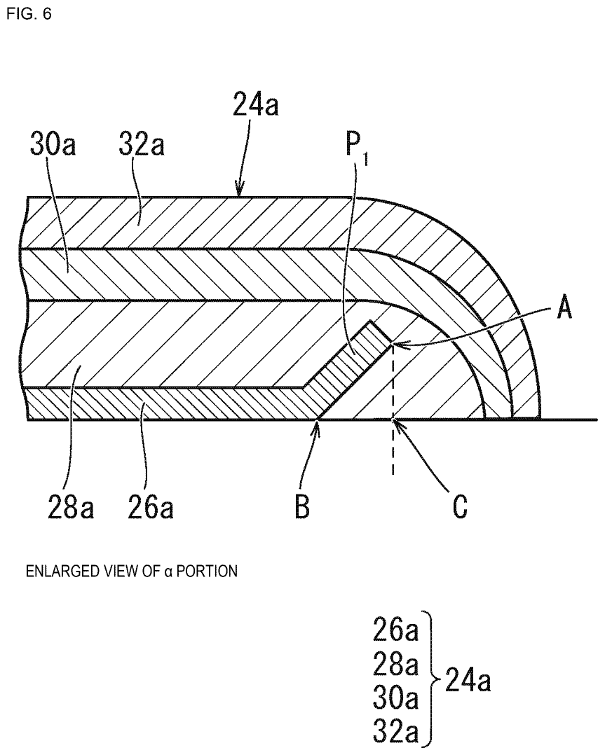

A multilayer ceramic capacitor 10 according to a first example embodiment of the present invention is described. FIG. 1 is an external perspective view illustrating a multilayer ceramic capacitor according to the first example embodiment of the present invention. FIG. 2 is a front view illustrating the multilayer ceramic capacitor according to the first example embodiment of the present invention. FIG. 3 is a top view illustrating the multilayer ceramic capacitor according to the first example embodiment of the present invention. FIG. 4 is a cross-sectional view taken along line IV-IV in FIG. 1. FIG. 5 is a cross-sectional view taken along line V-V in FIG. 1. FIG. 6 is an enlarged view of an a portion in FIG. 4.

The multilayer ceramic capacitor 10 includes a multilayer body 12 and an outer electrode 24. Configurations of the multilayer body 12 and the outer electrode 24 are described in this order.

The multilayer body 12 includes a plurality of laminated dielectric layers 14 and a plurality of laminated internal electrode layers 16. Furthermore, the multilayer body 12 includes a first main surface 12a and a second main surface 12b that are opposed to each other in a laminating direction x, a first side surface 12c and a second side surface 12d that are opposed to each other in a width direction y orthogonal or substantially orthogonal to the laminating direction x, and a first end surface 12e and a second end surface 12f that are opposed to each other in a length direction Z orthogonal or substantially orthogonal to the laminating direction x and the width direction y. The first main surface 12a and the second main surface 12b extend along the width direction y and the length direction z. The first side surface 12c and the second side surface 12d extend along the laminating direction x and the length direction z. The first end surface 12e and the second end surface 12f extend along the laminating direction x and the width direction y. Accordingly, the laminating direction x is a direction connecting the first main surface 12a and the second main surface 12b, the width direction y is a direction connecting the first side surface 12c and the second side surface 12d, and the length direction z is a direction connecting the first end surface 12e and the second end surface 12f. The first main surface 12a and the second main surface 12b, the first side surface 12c and the second side surface 12d, and the first end surface 12e and the second end surface 12f may be uneven surfaces or may be rough surfaces.

Corner portions and ridge portions of the multilayer body 12 are preferably rounded. The corner portions are portions where three adjacent surfaces of the multilayer body 12 cross, and the ridge portions are portions where adjacent two surfaces of the multilayer body 12 cross. By rounding the corner portions and ridge portions of the multilayer body 12, chipping and breakage of the multilayer body 12 can be prevented.

As illustrated in FIGS. 4 and 5, the multilayer body 12 includes an inner layer portion 15a where the plurality of internal electrode layers 16 face each other in the laminating direction connecting the first main surface 12a and the second main surface 12b, a first main-surface-side outer layer portion 15b1 including a plurality of dielectric layers 14 located between an internal electrode layer 16 closest to the first main surface 12a and the first main surface 12a, and a second main-surface-side outer layer portion 15b2 including a plurality of dielectric layers 14 located between an internal electrode layer 16 closest to the second main surface 12b and the second main surface 12b.

The dielectric layers 14 include an inner dielectric layer 14a, which is a dielectric layer 14 of the inner layer portion 15a, and outer dielectric layers 14b, which are dielectric layers 14 of the first main-surface-side outer layer portion 15b1 and the second main-surface-side outer layer portion 15b2.

The first main-surface-side outer layer portion 15b1 is a collection of a plurality of outer dielectric layers 14b that are located close to the first main surface 12a of the multilayer body 12 and are located between the first main surface 12a and the internal electrode layer 16 closest to the first main surface 12a.

The second main-surface-side outer layer portion 15b2 is a collection of a plurality of outer dielectric layers 14b that are located close to the second main surface 12b of the multilayer body 12 and are located between the second main surface 12b and the internal electrode layer 16 closest to the second main surface 12b.

The inner layer portion 15a is a region sandwiched between the first main-surface-side outer layer portion 15b1 and the second main-surface-side outer layer portion 15b2. That is, inner layer portion 15a is a region where the internal electrode layers 16 are laminated.

The inner layer portion 15a includes the inner dielectric layer 14a, a first internal electrode layer 16a that is laminated alternately with the inner dielectric layer 14a, and a second internal electrode layer 16b that is laminated alternately with the inner dielectric layer 14a. The first internal electrode layer 16a is exposed on the first end surface 12e. The second internal electrode layer 16b is exposed on the second end surface 12f.

The dielectric layers 14 can include, for example, a plurality of crystal grains including a perovskite compound whose basic structure is BaTiO₃.

The dielectric layers 14 can be, for example, made of a dielectric material. As the dielectric material, dielectric ceramics including BaTiO₃, CaTiO₃, SrTiO₃, CaZrO₃, or the like as a main component may be used, for example. In addition, an accessory component such as, for example, an Mn component, a Fe component, a Cr component, a Co component, or an Ni component may be added to such a main component.

The inner dielectric layer 14a and the outer dielectric layers 14b may be made of different materials in consideration of required functions. For example, use of a soft material for the outer dielectric layers 14b can mitigate stress applied to the multilayer body 12. Use of a solid material for the outer dielectric layers 14b can reduce or prevent the occurrence of a crack.

The first main-surface-side outer layer portion 15b1 and the second main-surface-side outer layer portion 15b2 are each a collection of a plurality of outer dielectric layers 14b. The plurality of outer dielectric layers 14b in each of the first main-surface-side outer layer portion 15bl and the second main-surface-side outer layer portion 15b2 may be integrated after baking and indistinguishable from one another.

The number of laminated dielectric layers 14 is not limited in particular, and is, for example, preferably equal to or greater than 30 and equal to or less than 90 including the outer dielectric layers 14b. A thickness of each of the dielectric layers 14 is, for example, preferably equal to or less than about 0.5 μm.

As illustrated in FIGS. 4 and 5, the internal electrode layers 16 include the first internal electrode layer 16a and the second internal electrode layer 16b. The first internal electrode layer 16a is laminated alternately with the dielectric layer 14 and is exposed on the first end surface 12e. The second internal electrode layer 16b is laminated alternately with the dielectric layer 14 and is exposed on the second end surface 12f. Specifically, the first internal electrode layer 16a and the second internal electrode layer 16b are alternately laminated with the inner dielectric layer 14a interposed therebetween.

The first internal electrode layer 16a is disposed on a surface of the inner dielectric layer 14a. The first internal electrode layer 16a includes a first opposed electrode portion 18a that faces the second internal electrode layer 16b and a first extended electrode portion 20a that is located at one end of the first internal electrode layer 16a and extends from the first opposed electrode portion 18a to the first end surface 12e of the multilayer body 12. An end portion of the first extended electrode portion 20a is extended to the first end surface 12e and is exposed.

A shape of the first opposed electrode portion 18a of the first internal electrode layer 16a is not limited in particular and is, for example, preferably rectangular or substantially rectangular in plan view. Corner portions of the first opposed electrode portion 18a in plan view may be rounded or the corner portions may be inclined (tapered) in plan view. Alternatively, the first opposed electrode portion 18a may have a tapered shape inclined toward one side in plan view.

A shape of the first extended electrode portion 20a of the first internal electrode layer 16a is not limited in particular and is, for example, preferably rectangular or substantially rectangular in plan view. Corner portions of the first extended electrode portion 20a in plan view may be rounded or the corner portions may be inclined (tapered) in plan view. Alternatively, the first extended electrode portion 20a may have a tapered shape inclined toward one side in plan view.

The first extended electrode portion 20a may be tapered so that a width thereof becomes narrower from the first opposed electrode portion 18a toward the first end surface 12e. That is, in a case where the first extended electrode portion 20a of the first internal electrode layer 16a has a tapered shape, a width of the first extended electrode portion 20a in the width direction y may be smaller than a width of the first opposed electrode portion 18a in the width direction y. However, this is not restrictive, and the width of the first extended electrode portion 20a may be the same or substantially the same as the width of the first opposed electrode portion 18a.

The second internal electrode layer 16b is disposed on a surface of the inner dielectric layer 14a different from the inner dielectric layer 14a on which the first internal electrode layer 16a is disposed. The second internal electrode layer 16b includes a second opposed electrode portion 18b that faces the first internal electrode layer 16a and a second extended electrode portion 20b that is located at one end of the second internal electrode layer 16b and extends from the second opposed electrode portion 18b to the second end surface 12f of the multilayer body 12. An end portion of the second extended electrode portion 20b is extended to the second end surface 12f and is exposed.

A shape of the second opposed electrode portion 18b of the second internal electrode layer 16b is not limited in particular and is, for example, preferably rectangular or substantially rectangular in plan view. Corner portions of the second opposed electrode portion 18b in plan view may be rounded or the corner portions may be inclined (tapered) in plan view. Alternatively, the second opposed electrode portion 18b may have a tapered shape inclined toward one side in plan view.

A shape of the second extended electrode portion 20b of the second internal electrode layer 16b is not limited in particular and is, for example, preferably rectangular or substantially rectangular in plan view. Corner portions of the second extended electrode portion 20b in plan view may be rounded or the corner portions may be inclined (tapered) in plan view. Alternatively, the second extended electrode portion 20b may have a tapered shape inclined toward one side in plan view.

The second extended electrode portion 20b may be tapered so that a width thereof becomes narrower from the second opposed electrode portion 18b toward the second end surface 12f. That is, in a case where the second extended electrode portion 20b of the second internal electrode layer 16b is tapered, a width of the second extended electrode portion 20b in the width direction y may be narrower than a width of the second opposed electrode portion 18b in the width direction y. However, this is not restrictive, and the width of the second extended electrode portion 20b may be the same or substantially the same as the width of the second opposed electrode portion 18b.

The first extended electrode portion 20a and the second extended electrode portion 20b may be curved toward the first main surface 12a or the second main surface 12b. Furthermore, a longest distance in the laminating direction x between an exposed portion of the first internal electrode layer 16a and an exposed portion of the second internal electrode layer 16b that are extended to the first end surface 12e or the second end surface 12f may be shorter than a longest distance in the laminating direction x between the first opposed electrode portion 18a of the first internal electrode layer 16a and the second opposed electrode portion 18b of the second internal electrode layer 16b.

The first internal electrode layer 16a and the second internal electrode layer 16b face each other with the inner dielectric layer 14a interposed therebetween, and as a result, an electrostatic capacitance is generated.

Furthermore, as illustrated in FIG. 4, the multilayer body 12 includes an end portion (hereinafter referred to as an “L gap”) 22b of the multilayer body 12 that is provided between an end portion of the first internal electrode layer 16a opposite to the first extended electrode portion 20a and the second end surface 12f and between an end portion of the second internal electrode layer 16b opposite to the second extended electrode portion 20b and the first end surface 12e.

As illustrated in FIG. 5, the multilayer body 12 includes a side portion (hereinafter referred to as a “W gap”) 22a of the multilayer body 12 that is provided between one end of each of the first opposed electrode portion 18a and the second opposed electrode portion 18b in the width direction y and the first side surface 12c and between the other end of each of the first opposed electrode portion 18a and the second opposed electrode portion 18b in the width direction y and the second side surface 12d.

The first internal electrode layer 16a and the second internal electrode layer 16b can be, for example, made of an appropriate conductive material such as a metal such as Ni, Cu, Ag, Pd, or Au or an alloy including one of these metals such as an Ag—Pd alloy.

The first internal electrode layer 16a and the second internal electrode layer 16b may include Sn, for example. In a case where the first internal electrode layer 16a and the second internal electrode layer 16b may include Sn, a potential barrier height of an interface between the first internal electrode layer 16a and the inner dielectric layer 14a and an interface between the second internal electrode layer 16b and the inner dielectric layer 14a can be increased, and a thickness of a depletion layer can be increased. This can reduce electric field concentration on the interfaces, leading to an improvement of high-temperature load reliability. Even in a case where only the first internal electrode layer 16a or the second internal electrode layer 16b includes Sn, the advantageous effects can be sufficiently produced.

To increase capacitance of the capacitor, the area of the internal electrode layers 16 needs to be increased. It is therefore preferable that LW plane coverage of the internal electrode layers 16 is, for example, equal to or greater than about 90%. The LW plane coverage is defined as a ratio obtained by subtracting an area of a gap from an area of an inside of edge portions of the internal electrode layers 16 viewed from a cross section (LW plane) of the multilayer body 12 in the width direction y and the length direction z. Although the capacitance of the capacitor becomes higher as the LW plane coverage becomes higher, the inner dielectric layers 14a are joined through the gap and therefore interlayer joint strength is high and interlayer peeling is less likely to occur even in a case where the LW plane coverage is low.

A thickness of each of the internal electrode layers 16, that is, the first internal electrode layer 16a and the second internal electrode layer 16b is, for example, preferably equal to or greater than about 0.3 μm and equal to or less than about 0.9 μm. The total number of first internal electrode layers 16a and second internal electrode layers 16b is, for example, preferably equal to or greater than 20 and equal to or less than 80.

The outer electrode 24 includes a first outer electrode 24a and a second outer electrode 24b.

The first outer electrode 24a is connected to the first internal electrode layer 16a and covers a portion of the first end surface 12e and a portion of the first main surface 12a of the multilayer body 12. The first outer electrode 24a may extend to cover a small portion of the second main surface 12b, a small portion of the first side surface 12c, and/or a small portion of the second side surface 12d.

The second outer electrode 24b is connected to the second internal electrode layer 16b and covers a portion of the second end surface 12f and a portion of the first main surface 12a of the multilayer body 12. The second outer electrode 24b may extend to cover a small portion of the second main surface 12b, a small portion of the first side surface 12c, and/or a small portion of the second side surface 12d.

The outer electrode 24, that is, each of the first outer electrode 24a and the second outer electrode 24b includes a thin film layer 26 that covers at least a portion of the first main surface 12a of the multilayer body 12, a lower plating layer 28 that covers at least a portion of the thin film layer 26, an upper plating layer 30 that is disposed on the lower plating layer 28, and a front plating layer 32 that is disposed on the upper plating layer 30.

The thin film layer 26 includes a first thin film layer 26a and a second thin film layer 26b.

The first thin film layer 26a covers a portion of the first main surface 12a that is close to the first end surface 12e of the multilayer body 12. The second thin film layer 26b covers a portion of the first main surface 12a that is close to the second end surface 12f of the multilayer body 12.

As illustrated in FIGS. 4 and 6, an end edge portion P₁ of the first thin film layer 26a that is located adjacent to a center of the multilayer body 12 in the length direction z is spaced apart from the multilayer body 12 in the laminating direction x. That is, the end edge portion P₁ of the first thin film layer 26a that is located close the center of the multilayer body 12 in the length direction z is floating above the multilayer body 12. Since the end edge portion P₁ of the first thin film layer 26a is continuously floating in the width direction y, tensile stress applied to the end edge portion P₁ of the first thin film layer 26a can be maintained small even upon application of thermal stress. This can reduce or prevent the occurrence of a crack in the multilayer body 12 caused by thermal stress.

As illustrated in FIGS. 4 and 6, among the end edge portion P₁ of the first thin film layer 26a that is located adjacent to the center of the multilayer body 12 in the length direction z, a position of the first thin film layer 26a that is closest in the length direction z to the center of the multilayer body 12 in the length direction z is referred to as a position A, a position at which the first thin film layer 26a begins to be spaced apart from the multilayer body 12 in the laminating direction x is referred to as a position B, and a position at which a perpendicular or substantially perpendicular line extending from the position A in the laminating direction x crosses the multilayer body 12 is referred to as a position C. It is preferable that ∠ABC is, for example, equal to or greater than about 20 degrees and equal to or less than about 70 degrees. By using the numerical range, the end edge portion P₁ of the first thin film layer 26a that is located adjacent to the center of the multilayer body 12 in the length direction z is sufficiently spaced apart from the multilayer body 12, and a distance from the position B to the position C in the length direction z can be made sufficient. Accordingly, a direction of compressive stress can be sufficiently changed. As a result, tensile stress applied to the end edge portion P₁ of the first thin film layer 26a can be maintained small even upon application of thermal stress. This can reduce or prevent the occurrence of a crack in the multilayer body 12 caused by thermal stress.

A distance from the position A to the position B in the length direction z is, for example, preferably equal to or greater than about 5 μm and equal to or less than about 20 μm. Since the distance from the position A to the position B can be thus made sufficient, the direction of the compressive stress can be sufficiently changed. On the other hand, in a case where the distance from the position A to the position B in the length direction z is less than about 5 μm, the end edge portion P₁ of the first thin film layer 26a that is located adjacent to the center of the multilayer body 12 in the length direction z cannot be sufficiently spaced apart from the multilayer body 12. In a case where the distance from the position A to the position B in the length direction z is larger than about 20 μm, a crack may undesirably occur in the multilayer body 12 due to excessive stress of the first thin film layer 26a.

As for the second thin film layer 26b, an end edge portion P₂ of the second thin film layer 26b that is located adjacent to the center of the multilayer body 12 in the length direction z is preferably spaced apart from the multilayer body 12 in the laminating direction x, as with the first thin film layer 26a. That is, the end edge portion P₂ of the second thin film layer 26b that is located adjacent to the center of the multilayer body 12 in the length direction z is floating above the multilayer body 12. Since the end edge portion P₂ of the second thin film layer 26b is continuously floating in the width direction y, tensile stress applied to the end edge portion P₂ of the second thin film layer 26b can be maintained small even upon application of thermal stress. This can reduce or prevent the occurrence of a crack in the multilayer body 12 caused by thermal stress.

Among positions of the end edge portion Pe of the second thin film layer 26b that is located adjacent to the center of the multilayer body 12 in the length direction z, a position of the second thin film layer 26b that is closest in the length direction z to the center of the multilayer body 12 in the length direction z is referred to as a position A, a position at which the second thin film layer 26b starts to be spaced apart from the multilayer body 12 in the laminating direction x is referred to as a position B, and a position at which a perpendicular or substantially perpendicular line extending from the position A in the laminating direction x crosses the multilayer body 12 is referred to as a position C. It is preferable that ∠ABC is, for example, equal to or greater than about 20 degrees and equal to or less than about 70 degrees. By using the numerical range, the end edge portion P₂ of the second thin film layer 26b that is located adjacent to the center of the multilayer body 12 in the length direction z is sufficiently spaced apart from the multilayer body 12, and a distance from the position B to the position C in the length direction z can be made sufficient. Accordingly, a direction of compressive stress can be sufficiently changed. As a result, tensile stress applied to the end edge portion P₂ of the second thin film layer 26b can be maintained small even upon application of thermal stress. This can reduce or prevent the occurrence of a crack in the multilayer body 12 caused by thermal stress.

A distance from the position A to the position B in the length direction z is, for example, preferably equal to or greater than about 5 μm and equal to or less than about 20 μm. Since the distance from the position A to the position B can be thus made sufficient, the direction of the compressive stress can be sufficiently changed. On the other hand, in a case where the distance from the position A to the position B in the length direction z is less than about 5 μm, the end edge portion Pe of the second thin film layer 26b that is located adjacent to the center of the multilayer body 12 in the length direction z cannot be sufficiently spaced apart from the multilayer body 12. In a case where the distance from the position A to the position B in the length direction z is larger than about 20 μm, a crack may undesirably occur in the multilayer body 12 due to excessive stress of the second thin film layer 26b.

The end edge portions P₁ and P₂ of the thin film layer 26 may have a discontinuous shape. The “discontinuous shape” means that the end edge portions P₁ and P₂ of the thin film layer 26 are discontinuous in plan view.

The thin film layer 26 is formed by, for example, depositing metal particles. The thin film layer 26 is preferably formed by a thin film formation method such as, for example, a sputtering method, a vapor deposition method, a chemical vapor deposition (CVD) method, or an atomic layer deposition (ALD) method. By thus forming the thin film layer 26, a thickness of the thin film layer 26 in the laminating direction x can be, for example, equal to or less than about 1.0 μm. Accordingly, a thickness of the multilayer ceramic capacitor 10 in the laminating direction x can be made small. The thin film layer 26 may be formed by, for example, screen printing or the like.

The thickness of the thin film layer 26 can be, for example, calculated from a concentration of a predetermined element by performing a calibration curve method on a target metal species by using a fluorescence X-ray analyzer. Alternatively, the thickness and the like can be measured from an actual observation image of a component cross section obtained by a focused ion beam (FIB) by using a scanning electron microscope.

The thin film layer 26 may include ceramics and a metal component. In a case where the thin film layer 26 includes ceramics and a metal component, the thin film layer 26 and the dielectric ceramics included in the dielectric layers 14 of the multilayer body 12 are fixed. This can further improve fixing strength between the multilayer body 12 and the outer electrode 24.

The metal component of the thin film layer 26 preferably, for example, includes Cu or Ni as a main component mixed with about 1 vol % of Cr, V, Ti, Co, or Mn.

A particle size of the metal component of the thin film layer 26 is preferably, for example, equal to or less than about 1.0 μm. By setting the particle size of the metal component of the thin film layer 26 small, compressive stress of the entire thin film layer 26 can be made small.

To measure the particle size of the metal component of the thin film layer 26, for example, an LT cross section at a position of about ½ of the dimension of the multilayer ceramic capacitor 10 in the width direction y is exposed, and the cross section of the thin film layer 26 is observed by an electronic microscope. A magnification is, for example, preferably about 20000 or more. Ten lines are drawn on an observed surface, which is the cross section of the thin film layer 26, at equal or substantially equal intervals in the laminating direction x, maximum particle sizes of metal particles on the lines are measured, and an average of the maximum particle sizes is calculated as the particle size.

In a case where the thin film layer 26 includes ceramics, the LT cross section at the position of about ½ of the dimension of the multilayer ceramic capacitor 10 in the width direction y is exposed, and a photograph of the cross section is acquired by using a digital microscope (VHX-5000 produced by Keyence Corporation). The thickness can be calculated from the photograph of the cross section. Alternatively, the thickness and the like can be measured from an actual observation image of a component cross section obtained by a focused ion beam (FIB) by using a scanning electron microscope.

A thickness of the first thin film layer 26a and the second thin film layer 26b in the laminating direction x is, for example, preferably equal to or greater than about 50 nm and equal to or less than about 500 nm.

The lower plating layer 28 includes a first lower plating layer 28a and a second lower plating layer 28b. The lower plating layer 28 is disposed on the thin film layer 26 and on the first end surface 12e and the second end surface 12f. The lower plating layer 28 is provided so as be in between the multilayer body 12 and the thin film layer 26.

The first lower plating layer 28a is disposed on the first end surface 12e of the multilayer body 12, on which the thin film layer 26 is not disposed, and covers the first thin film layer 26a disposed on the first main surface 12a.

The second lower plating layer 28b is disposed on the second end surface 12f of the multilayer body 12, on which the thin film layer 26 is not disposed, and covers the second thin film layer 26b disposed on the first main surface 12a.

This makes it possible to uniformly provide the upper plating layer 30 and the front plating layer 32, thus keeping variations in thicknesses of the upper plating layer 30 and the front plating layer 32 small.

The lower plating layer 28 may extend from the first main surface 12a to the first end surface 12e or the second end surface 12f. Furthermore, the lower plating layer 28 may extend to the first side surface 12c and/or the second side surface 12d. In a case where the lower plating layer 28 extends from the first main surface 12a to the first end surface 12e or the second end surface 12f, the internal electrode layers 16 and the lower plating layer 28 are preferably connected.

In the present example embodiment, the lower plating layer 28 is, for example, a Cu plating layer. In a case where the lower plating layer 28 is a Cu plating layer and covers a surface of the thin film layer 26, an advantageous effect of reducing or preventing intrusion of a plating solution is provided.

A thickness of the first lower plating layer 28a and the second lower plating layer 28b in the laminating direction x is, for example, preferably equal to or greater than about 50 nm and equal to or less than about 500 nm.

The upper plating layer 30 includes a first upper plating layer 30a and a second upper plating layer 30b.

The first upper plating layer 30a covers the first lower plating layer 28a. Specifically, the first upper plating layer 30a is preferably disposed on a surface of the first lower plating layer 28a disposed on the first end surface 12e and extends to a surface of the first lower plating layer 28a disposed on the first main surface 12a. The first upper plating layer 30a may be disposed only on the surface of the first lower plating layer 28a disposed on the first end surface 12e.

The second upper plating layer 30b covers the second lower plating layer 28b. Specifically, the second upper plating layer 30b is preferably disposed on a surface of the second lower plating layer 28b disposed on the second end surface 12f and extends to a surface of the second lower plating layer 28b disposed on the first main surface 12a. The second upper plating layer 30b may be disposed only on the surface of the second lower plating layer 28b disposed on the second end surface 12f.

The upper plating layer 30 is, for example, preferably a Ni plating layer having a solder barrier effect. In the present example embodiment, the upper plating layer 30 is, for example, a Ni plating layer.

A thickness of the upper plating layer 30 in the laminating direction x is, for example, preferably equal to or greater than about 1 μm and equal to or less than about 9 μm.

The front plating layer 32 includes a first front plating layer 32a and a second front plating layer 32b.

The first front plating layer 32a covers the first upper plating layer 30a. Specifically, the first front plating layer 32a is preferably disposed on a surface of the first upper plating layer 30a disposed on the first end surface 12e and extends to a surface of the first upper plating layer 30a disposed on the first main surface 12a.

The second front plating layer 32b covers the second upper plating layer 30b. Specifically, the second front plating layer 32b is preferably disposed on a surface of the second upper plating layer 30b disposed on the second end surface 12f and extends to a surface of the second upper plating layer 30b disposed on the first main surface 12a.

The front plating layer 32 can be, for example, an Sn plating layer having good joinability with solder, a Cu plating layer in view of demands for being embedded in a substrate, or the like, but is not limited to this.

A thickness of the front plating layer 32 in the laminating direction x is, for example, preferably equal to or greater than about 1 μm and equal to or less than about 7 μm.

A dimension, in the length direction z, of the multilayer ceramic capacitor 10 including the multilayer body 12, the first outer electrode 24a, and the second outer electrode 24b is referred to as an L dimension, a dimension, in the laminating direction x, of the multilayer ceramic capacitor 10 including the multilayer body 12, the first outer electrode 24a, and the second outer electrode 24b is referred to as a T dimension, and a dimension, in the width direction y, of the multilayer ceramic capacitor 10 including the multilayer body 12, the first outer electrode 24a, and the second outer electrode 24b is referred to as a W dimension.

The dimensions of the multilayer ceramic capacitor 10 are, for example, preferably set so that the L dimension in the length direction z is equal to or greater than about 200 mm and equal to or less than about 900 mm, the W dimension in the width direction y is equal to or greater than about 200 mm and equal to or less than about 900 mm, and the T dimension in the laminating direction x is equal to or greater than about 50 μm and equal to or less than about 300 mm.

The multilayer ceramic capacitor 10 can effectively produce the advantageous effects of the present invention in a case where a sum (the T dimension) of the thickness of each of the first outer electrode 24a and the second outer electrode 24b disposed on the first main surface 12a and the thickness of the multilayer body 12 in the laminating direction x is, for example, equal to or less than about 80 μm. The advantageous effects are more effective in a case where the T dimension of the multilayer ceramic capacitor 10 in the laminating direction x is, for example, equal to or less than about 55 μm, more preferably equal to or less than about 50 μm.

According to the multilayer ceramic capacitor 10 illustrated in FIG. 1, the end edge portions P₁ and P₂ of the thin film layer 26 that are located adjacent to the center of the multilayer body 12 in the length direction z are spaced apart from the multilayer body 12, and therefore stress applied to the end edge portions P₁ and P₂ of the thin film layer 26 is dispersed. This can reduce or prevent extension of a crack into an inside of the multilayer ceramic capacitor 10.

According to the multilayer ceramic capacitor 10 illustrated in FIG. 1, assuming that among positions of the end edge portions P₁ and P₂ of the thin film layer 26 that are located adjacent to the center of the multilayer body 12 in the length direction z, a position of the thin film layer 26 that is closest to the center of the multilayer body 12 in the length direction z is a position A, a position at which thin film layer 26 starts to be spaced apart from the multilayer body 12 in the laminating direction x is a position B, and a position at which a perpendicular or substantially perpendicular line extending from the position A in the laminating direction x crosses the multilayer body 12 is a position C, ∠ABC is, for example, equal to or greater than about 20 degrees and equal to or less than about 70 degrees. Therefore, the end edge portions P₁ and P₂ of the thin film layer 26 that are located adjacent to the center of the multilayer body 12 in the length direction z are sufficiently spaced apart from the multilayer body 12, and a sufficient distance can be provided. Accordingly, a direction of compressive stress can be sufficiently changed. As a result, tensile stress applied to the end edge portions P₁ and P₂ of the thin film layer 26 can be maintained small even upon application of thermal stress. This can reduce or prevent the occurrence of a crack in the multilayer body 12 caused by thermal stress.

Furthermore, according to the multilayer ceramic capacitor 10 illustrated in FIG. 1, assuming that among positions of the end edge portions P₁ and P₂ of the thin film layer 26 that are located adjacent to the center of the multilayer body 12 in the length direction z, a position of the thin film layer 26 that is closest to the center of the multilayer body 12 in the length direction z is a position A and a position at which the thin film layer 26 starts to be spaced apart from the multilayer body 12 in the laminating direction x is a position B, a distance from the position A to the position B in the length direction z is, for example, equal to or greater than about 5 μm and is equal to or less than about 20 μm, and therefore the distance from the position A to the position B can be made sufficient. Accordingly, a direction of compressive stress can be sufficiently changed.

Furthermore, according to the multilayer ceramic capacitor 10 illustrated in FIG. 1, the metal particle diameter of the thin film layer 26 is, for example, equal to or less than about 1.0 μm, and therefore compressive stress of the entire thin film layer 26 can be reduced.

Furthermore, according to the multilayer ceramic capacitor 10 illustrated in FIG. 1, the sum of the thickness of each of the first outer electrode 24a and the second outer electrode 24b disposed on the first main surface 12a and the thickness of the multilayer body 12 in the laminating direction x is, for example, equal to or less than about 80 μm, and therefore the above advantageous effects of the present invention can be effectively produced.

### 2. Method for Producing Multilayer Ceramic Capacitor

An example of a method for producing the multilayer ceramic capacitor 10 according to the first example embodiment is described.

First, a ceramic green sheet and conductive paste for internal electrode are prepared. The dielectric sheet and the conductive paste for internal electrode include a binder (e.g., a publicly-known organic binder) and a solvent (e.g., a publicly-known organic solvent).

Next, the conductive paste for internal electrode is applied in a predetermined pattern on the ceramic green sheet, for example, by screen printing, gravure printing, or the like, and thus an internal electrode pattern is formed. Specifically, a conductive paste layer is formed by applying paste made of a conductive material onto the ceramic green sheet by a method such as the above printing method. The paste made of a conductive material is, for example, produced by adding an organic binder and an organic solvent to metal powder. As for the ceramic green sheet, a ceramic green sheet for outer layer on which no internal electrode pattern is printed is also produced.

A multilayer sheet is produced by using such ceramic green sheets on which the internal electrode pattern is formed. Specifically, the multilayer sheet is produced by laminating a predetermined number of ceramic green sheets for outer layer on which no internal electrode pattern is formed, alternately laminating thereon a ceramic green sheet on which an internal electrode pattern corresponding to the first internal electrode layer 16a is formed and a ceramic green sheet on which an internal electrode pattern corresponding to the second internal electrode layer 16b is formed, and laminating thereon a predetermined number of ceramic green sheets for outer layer on which no internal electrode pattern is formed.

Furthermore, a multilayer block is produced by pressing the multilayer sheet in a laminating direction by, for example, isostatic press.

Subsequently, the multilayer block is cut into a predetermined size, and a multilayer chip is thus cut out. In this process, corner portions and ridge portions of the multilayer chip may be rounded by barrel polishing, for example.

Next, the multilayer chip is baked to produce the multilayer body 12. A baking temperature is, for example, preferably equal to or greater than about 900° C. and equal to or less than about 1400° C. although the baking temperature depends on materials used for the ceramics and internal electrode.

Subsequently, the thin film layer 26 is formed on a portion of the first main surface 12a of the multilayer body 12.

For example, a resist made of a resin or the like is disposed on the first main surface 12a of the multilayer body 12, and the first thin film layer 26a and the second thin film layer 26b are disposed on the resist and the first main surface 12a of the multilayer body 12 by, for example, a sputtering method, a screen printing method, or the like. Then, a resist portion is peeled. In this way, the end edge portion P₁ of the first thin film layer 26a that is located adjacent to the center of the multilayer body 12 in the length direction z and the end edge portion P₂ of the second thin film layer 26b that is located adjacent to the center of the multilayer body 12 in the length direction z can be spaced apart from the multilayer body 12 in the laminating direction x.

Then, for example, a Cu plating layer that is the lower plating layer 28 is formed so as to directly cover the thin film layer 26 and the first end surface 12e and the second end surface 12f of the multilayer body 12, on which the thin film layer 26 is not disposed. At the end edge portion P₁ of the first thin film layer 26a that is located adjacent to the center of the multilayer body 12 in the length direction z and the end edge portion P₂ of the second thin film layer 26b that is located adjacent to the center of the multilayer body 12 in the length direction z, the lower plating layer 28 is formed so as to be in between the multilayer body 12 and the thin film layer 26.

Subsequently, for example, a Ni plating layer that is the upper plating layer 30 is formed on a surface of the lower plating layer 28. Then, a Sn plating layer that is the front plating layer 32 is formed on a surface of the upper plating layer 30. At the time of formation of the lower plating layer 28, the upper plating layer 30, and the front plating layer 32, for example, electrolytic plating using an electrolytic plating bath mixed with an additive or electroless plating using substitution reaction is performed.

By disposing a resist on the first main surface 12a after formation of the thin film layer 26 and performing electrolytic plating or electroless plating, an end edge portion of the lower plating layer 28 that is located adjacent to the center of the multilayer body 12 in the length direction z can be spaced apart from the multilayer body 12 in the laminating direction x. The resist may be disposed after formation and baking of the thin film layer 26.

In this way, the multilayer ceramic capacitor 10 illustrated in FIG. 1 can be produced.

### B. Second Example Embodiment

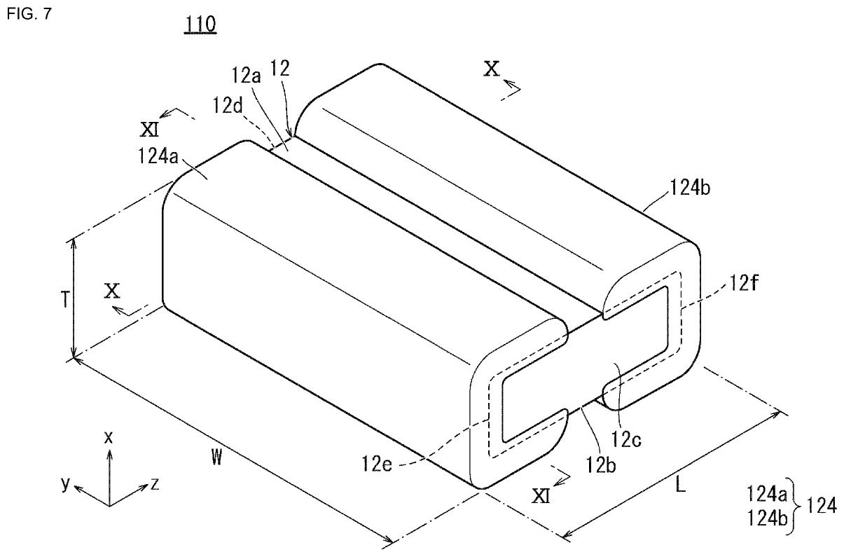

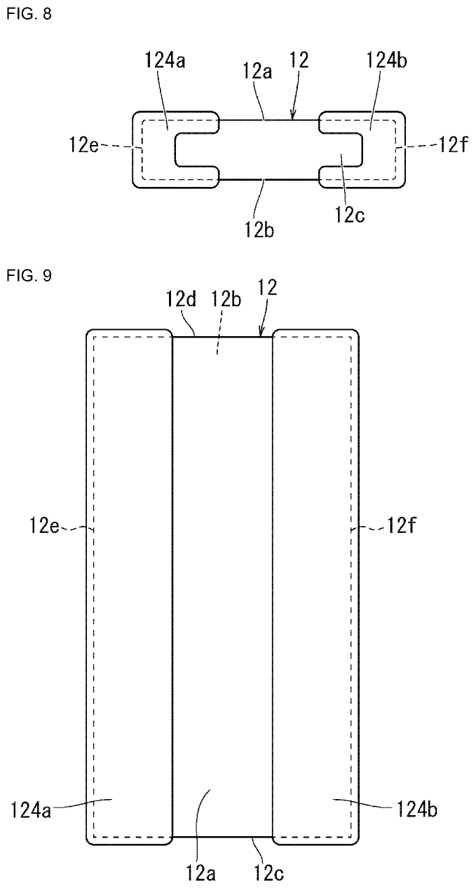

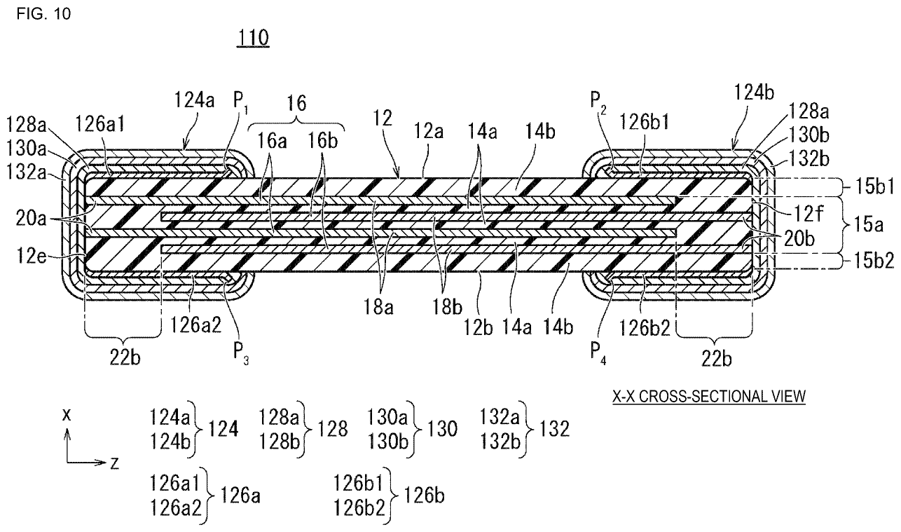

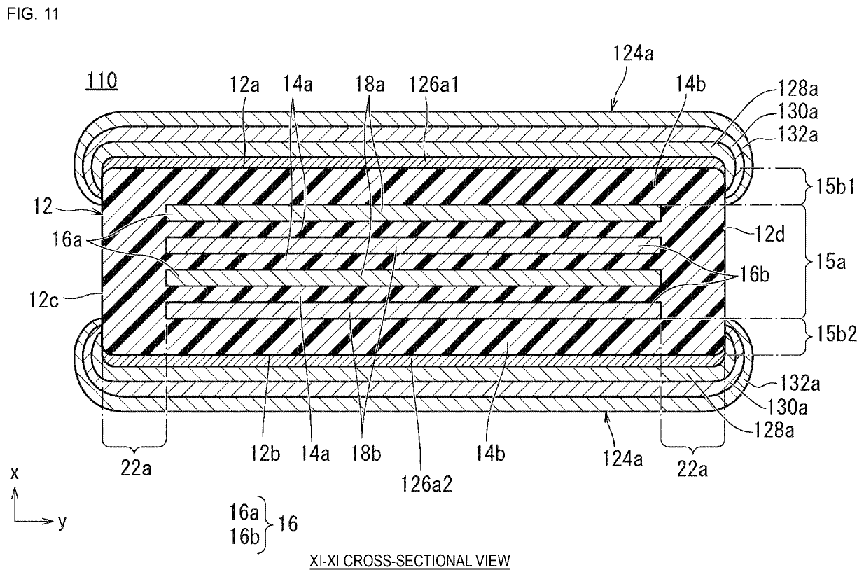

Next, a multilayer ceramic capacitor 110 according to a second example embodiment of the present invention is described. FIG. 7 is an external perspective view illustrating a multilayer ceramic capacitor according to the second example embodiment of the present invention. FIG. 8 is a front view illustrating the multilayer ceramic capacitor according to the second example embodiment of the present invention. FIG. 9 is a top view illustrating the multilayer ceramic capacitor according to the second example embodiment of the present invention. FIG. 10 is a cross-sectional view taken along line X-X in FIG. 7. FIG. 11 is a cross-sectional view taken along line XI-XI in FIG. 7.

The multilayer ceramic capacitor 110 according to the second example embodiment is different from the multilayer ceramic capacitor 10 according to the first example embodiment in that a thin film layer 26 is disposed not only on a first main surface 12a but also on a second main surface 12b and in that a dimension of the multilayer ceramic capacitor in a length direction z and a dimension of the multilayer ceramic capacitor in a width direction y are different. Accordingly, elements corresponding to those in the first example embodiment are denoted by the same reference signs, and detailed description thereof is omitted.

The multilayer ceramic capacitor 110 includes a multilayer body 12 and an outer electrode 124.

The multilayer body 12 includes a plurality of dielectric layers 14 and a plurality of internal electrode layers 16 that are laminated.

As illustrated in FIGS. 10 and 11, the multilayer body 12 includes an inner layer portion 15a in which the plurality of internal electrode layers 16 face each other in a laminating direction x connecting the first main surface 12a and the second main surface 12b, a first main-surface-side outer layer portion 15b1 including a plurality of dielectric layers 14 that are located between an internal electrode layer 16 closest to the first main surface 12a and the first main surface 12a, and a second main-surface-side outer layer portion 15b2 including a plurality of dielectric layers 14 that are located between an internal electrode layer 16 closest to the second main surface 12b and the second main surface 12b.

The inner layer portion 15a includes an inner dielectric layer 14a, a first internal electrode layer 16a that is laminated alternately with the inner dielectric layer 14a, and a second internal electrode layer 16b that is laminated alternately with the inner dielectric layer 14a. The first internal electrode layer 16a may be exposed on a first end surface 12e, a first side surface 12c, and a second side surface 12d, and the second internal electrode layer 16b may be exposed on a second end surface 12f, the first side surface 12c, and the second side surface 12d.

The outer electrode 124 includes a first outer electrode 124a and a second outer electrode 124b.

The first outer electrode 124a is connected to the first internal electrode layer 16a and covers the first end surface 12e and a portion of the first main surface 12a and a portion of the second main surface 12b. Furthermore, the first outer electrode 124a may extend to a small portion of the first side surface 12c and a small portion of the second side surface 12d. This is not restrictive, and the first outer electrode 124a may cover only the first main surface or the second main surface.

The second outer electrode 124b is connected to the second internal electrode layer 16b and covers the second end surface 12f and a portion of the first main surface 12a and a portion of the second main surface 12b. The second outer electrode 124b may extend to a small portion of the first side surface 12c and a small portion of the second side surface 12d. This is not restrictive, and the second outer electrode 124b may cover only the first main surface or the second main surface.

The outer electrode 124 includes a thin film layer 126 that is disposed on at least one of the first main surface 12a, the second main surface 12b, the first end surface 12e, and the second end surface 12f, a lower plating layer 128 that covers the thin film layer 126, an upper plating layer 130 that covers the lower plating layer 128, and a front plating layer 132 that covers the upper plating layer 130.

In the present example embodiment, the thin film layer 126 of the outer electrode 124 is disposed not only on the first main surface 12a, but also on the second main surface 12b.

The thin film layer 126 includes a first thin film layer 126a and a second thin film layer 126b.

The first thin film layer 126a includes a first main-surface-side thin film layer 126al that covers a portion of the first main surface 12a that is close to the first end surface 12e of the multilayer body 12 and a third main-surface-side thin film layer 126a2 that covers a portion of the second main surface 12b that is close to the first end surface 12e of the multilayer body 12.

The second thin film layer 126b includes a second main-surface-side thin film layer 126b1 that covers a portion of the first main surface 12a that is close to the second end surface 12f of the multilayer body 12 and a fourth main-surface-side thin film layer 126b2 that covers a portion of the second main surface 12b that is close to the second end surface 12f of the multilayer body 12.

An end edge portion P₁ of the first main-surface-side thin film layer 126al that is located adjacent to a center of the multilayer body 12 in the length direction z is spaced apart from the multilayer body 12 in the laminating direction x. That is, the end edge portion P₁ of the first main-surface-side thin film layer 126al that is located adjacent to the center of the multilayer body 12 in the length direction z is floating above the multilayer body 12. Since the end edge portion P₁ of the first main-surface-side thin film layer 126al is continuously floating in the width direction y, tensile stress applied to the end edge portion P₁ of the first main-surface-side thin film layer 126a1 can be maintained small even upon application of thermal stress. This makes it possible to reduce or prevent the occurrence of a crack in the multilayer body 12 caused by thermal stress.

Among positions of the end edge portion P₁ of the first main-surface-side thin film layer 126a1 that is located adjacent to the center of the multilayer body 12 in the length direction z, a position of the first main-surface-side thin film layer 126a1 that is closest in the length direction z to the center of the multilayer body 12 in the length direction z is referred to as a position A, a position at which the first main-surface-side thin film layer 126al starts to be spaced apart from the multilayer body 12 in the laminating direction x is referred to as a position B, and a position at which a perpendicular or substantially perpendicular line extending from the position A in the laminating direction x crosses the multilayer body 12 is referred to as a position C. It is preferable that ∠ABC is, for example, equal to or greater than about 20 degrees and equal to or less than about 70 degrees. By using the numerical range, the end edge portion P₁ of the first main-surface-side thin film layer 126al that is located adjacent to the center of the multilayer body 12 in the length direction z is sufficiently spaced apart from the multilayer body 12, and a distance from the position B to the position C in the length direction z can be made sufficient. Accordingly, a direction of compressive stress can be sufficiently changed. As a result, tensile stress applied to the end edge portion P₁ of the first main-surface-side thin film layer 126al can be maintained small even upon application of thermal stress. This can reduce or prevent the occurrence of a crack in the multilayer body 12 caused by thermal stress.

A distance from the position A to the position B in the length direction z is, for example, preferably equal to or greater than about 5 μm and equal to or less than about 20 μm. Accordingly, the distance from the position A to the position B can be made sufficient, and therefore the direction of the compressive stress can be sufficiently changed. On the other hand, in a case where the distance from the position A to the position B in the length direction z is less than about 5 μm, the end edge portion P₁ of the first main-surface-side thin film layer 126a1 that is located adjacent to the center of the multilayer body 12 in the length direction z cannot be sufficiently spaced apart from the multilayer body 12. In a case where the distance from the position A to the position B in the length direction z is larger than about 20 μm, a crack may undesirably occur in the multilayer body 12 due to excessive stress of the first main-surface-side thin film layer 126a1.

As for the second main-surface-side thin film layer 126b1, an end edge portion P₂ of the second main-surface-side thin film layer 126b1 that is located adjacent to the center of the multilayer body 12 in the length direction z is spaced apart from the multilayer body 12 in the laminating direction x, as with the first main-surface-side thin film layer 126a1. That is, the end edge portion P₂ of the second main-surface-side thin film layer 126b1 that is located adjacent to the center of the multilayer body 12 in the length direction z is floating above the multilayer body 12. Since the end edge portion P₂ of the second main-surface-side thin film layer 126b1 is continuously floating in the width direction y, tensile stress applied to the end edge portion P₂ of the second main-surface-side thin layer 126b1 can be maintained small even upon application of thermal stress. This can reduce or prevent the occurrence of a crack in the multilayer body 12 caused by thermal stress.

Among positions of the end edge portion P₂ of the second main-surface-side thin film layer 126b1 that is located adjacent to the center of the multilayer body 12 in the length direction z, a position of the second main-surface-side thin film layer 126b1 that is closest in the length direction z to the center of the multilayer body 12 in the length direction z is referred to as a position A, a position at which the second main-surface-side thin film layer 126b1 starts to be spaced apart from the multilayer body 12 in the laminating direction x is referred to as a position B, and a position at which a perpendicular or substantially perpendicular line extending from the position A in the laminating direction x crosses the multilayer body 12 is referred to as a position C. It is preferable that ∠ABC is, for example, equal to or greater than about 20 degrees and equal to or less than about 70 degrees. By using the numerical range, the end edge portion P₂ of the second main-surface-side thin film layer 126b1 that is located adjacent to the center of the multilayer body 12 in the length direction z is sufficiently spaced apart from the multilayer body 12, and a distance from the position B to the position C in the length direction z can be made sufficient. Accordingly, a direction of compressive stress can be sufficiently changed. As a result, tensile stress applied to the end edge portion Pe of the second main-surface-side thin film layer 126b1 can be maintained small even upon application of thermal stress. This can reduce or prevent the occurrence of a crack in the multilayer body 12 caused by thermal stress.

A distance from the position A to the position B in the length direction z is, for example, preferably equal to or greater than about 5 μm and equal to or less than about 20 μm. Accordingly, the distance from the position A to the position B can be made sufficient, and therefore the direction of the compressive stress can be sufficiently changed. On the other hand, in a case where the distance from the position A to the position B in the length direction z is less than about 5 μm, the end edge portion Pe of the second main-surface-side thin film layer 126b1 that is located adjacent to the center of the multilayer body 12 in the length direction z cannot be sufficiently spaced apart from the multilayer body 12. In a case where the distance from the position A to the position B in the length direction z is larger than about 20 μm, a crack may undesirably occur in the multilayer body 12 due to excessive stress of the second main-surface-side thin film layer 126b1.

As for the third main-surface-side thin film layer 126a2, an end edge portion P₃ of the third main-surface-side thin film layer 126a2 that is located adjacent to the center of the multilayer body 12 in the length direction z is spaced apart from the multilayer body 12 in the laminating direction x, as with the first main-surface-side thin film layer 126al. That is, the end edge portion P₃ of the third main-surface-side thin film layer 126a2 that is located adjacent to the center of the multilayer body 12 in the length direction z is floating above the multilayer body 12. Since the end edge portion P₃ of the third main-surface-side thin film layer 126a2 is continuously floating in the width direction y, tensile stress applied to the end edge portion P₃ of the third main-surface-side thin film layer 126a2 can be maintained small even upon application of thermal stress. This can reduce or prevent the occurrence of a crack in the multilayer body 12 caused by thermal stress.

Among positions of the end edge portion P₃ of the third main-surface-side thin film layer 126a2 that is located adjacent to the center of the multilayer body 12 in the length direction z, a position of the third main-surface-side thin film layer 126a2 that is closest in the length direction z to the center of the multilayer body 12 in the length direction z is referred to as a position A, a position at which the third main-surface-side thin film layer 126a2 starts to be spaced apart from the multilayer body 12 in the laminating direction x is referred to as a position B, and a position at which a perpendicular or substantially perpendicular line extending from the position A in the laminating direction x crosses the multilayer body 12 is referred to as a position C. It is preferable that ∠ABC is, for example, equal to or greater than about 20 degrees and equal to or less than about 70 degrees. By using the numerical range, the end edge portion P₃ of the third main-surface-side thin film layer 126a2 that is located adjacent to the center of the multilayer body 12 in the length direction z is sufficiently spaced apart from the multilayer body 12, and a distance from the position B to the position C in the length direction z can be made sufficient. Accordingly, a direction of compressive stress can be sufficiently changed. As a result, tensile stress applied to the end edge portion P₃ of the third main-surface-side thin film layer 126a2 can be maintained small even upon application of thermal stress. This can reduce or prevent the occurrence of a crack in the multilayer body 12 caused by thermal stress.

A distance from the position A to the position B in the length direction z is, for example, preferably equal to or greater than about 5 μm and equal to or less than about 20 μm. Accordingly, the distance from the position A to the position B can be made sufficient, and therefore the direction of the compressive stress can be sufficiently changed. On the other hand, in a case where the distance from the position A to the position B in the length direction z is less than about 5 μm, the end edge portion P₃ of the third main-surface-side thin film layer 126a2 that is located adjacent to the center of the multilayer body 12 in the length direction z cannot be sufficiently spaced apart from the multilayer body 12. In a case where the distance from the position A to the position B in the length direction z is larger than about 20 μm, a crack may undesirably occur in the multilayer body 12 due to excessive stress of the third main-surface-side thin film layer 126a2.

As for the fourth main-surface-side thin film layer 126b2, an end edge portion P₄ of the fourth main-surface-side thin film layer 126b2 that is located adjacent to the center of the multilayer body 12 in the length direction z is spaced apart from the multilayer body 12 in the laminating direction x, as with the second main-surface-side thin film layer 126b1. That is, the end edge portion P₄ of the fourth main-surface-side thin film layer 126b2 that is located adjacent to the center of the multilayer body 12 in the length direction z is floating above the multilayer body 12. Since the end edge portion P₄ of the fourth main-surface-side thin film layer 126b2 is continuously floating in the width direction y, tensile stress applied to the end edge portion P₄ of the fourth main-surface-side thin film layer 126b2 can be maintained small even upon application of thermal stress. This can reduce or prevent the occurrence of a crack in the multilayer body 12 caused by thermal stress.

Among positions of the end edge portion P₄ of the fourth main-surface-side thin film layer 126b2 that is located adjacent to the center of the multilayer body 12 in the length direction z, a position of the fourth main-surface-side thin film layer 126b2 that is closest in the length direction z to the center of the multilayer body 12 in the length direction z is referred to as a position A, a position at which the fourth main-surface-side thin film layer 126b2 starts to be spaced apart from the multilayer body 12 in the laminating direction x is referred to as a position B, and a position at which a perpendicular or substantially perpendicular line extending from the position A in the laminating direction x crosses the multilayer body 12 is referred to as a position C. It is preferable that ∠ABC is, for example, equal to or greater than about 20 degrees and equal to or less than about 70 degrees. By using the numerical range, the end edge portion P₄ of the fourth main-surface-side thin film layer 126b2 that is located adjacent to the center of the multilayer body 12 in the length direction z is sufficiently spaced apart from the multilayer body 12, and a distance from the position B to the position C in the length direction z can be made sufficient. Accordingly, a direction of compressive stress can be sufficiently changed. As a result, tensile stress applied to the end edge portion P₄ of the fourth main-surface-side thin film layer 126b2 can be maintained small even upon application of thermal stress. This can reduce or prevent the occurrence of a crack in the multilayer body 12 caused by thermal stress.

A distance from the position A to the position B in the length direction z is, for example, preferably equal to or greater than about 5 μm and equal to or less than about 20 μm. Accordingly, the distance from the position A to the position B can be made sufficient, and therefore the direction of the compressive stress can be sufficiently changed. On the other hand, in a case where the distance from the position A to the position B in the length direction z is less than about 5 μm, the end edge portion P₄ of the fourth main-surface-side thin film layer 126b2 that is located adjacent to the center of the multilayer body 12 in the length direction z cannot be sufficiently spaced apart from the multilayer body 12. In a case where the distance from the position A to the position B in the length direction z is larger than about 20 μm, a crack may undesirably occur in the multilayer body 12 due to excessive stress of the fourth main-surface-side thin film layer 126b2.

The lower plating layer 128 includes a first lower plating layer 128a and a second lower plating layer 128b. The lower plating layer 128 is disposed on the thin film layer 126 and is disposed on the first end surface 12e and the second end surface 12f. The lower plating layer 128 is provided so as to be in between the multilayer body 12 and the thin film layer 126.

The first lower plating layer 128a is disposed on the first end surface 12e of the multilayer body 12 on which the thin film layer 126 is not disposed and covers the first main-surface-side thin film layer 126al disposed on the first main surface 12a and the third main-surface-side thin film layer 126a2 disposed on the second main surface 12b.

The second lower plating layer 128b is disposed on the second end surface 12f of the multilayer body 12 on which the thin film layer 126 is not disposed and covers the second main-surface-side thin film layer 126b1 disposed on the first main surface 12a and the fourth main-surface-side thin film layer 126b2 disposed on the second main surface 12b.

The upper plating layer 130 includes a first upper plating layer 130a and a second upper plating layer 130b. The first upper plating layer 130a covers the first lower plating layer 128a. The second upper plating layer 130b covers the second lower plating layer 128b.

The front plating layer 132 includes a first front plating layer 132a and a second front plating layer 132b. The first front plating layer 132a covers the first upper plating layer 130a. The second front plating layer 132b covers the second upper plating layer 130b.

As illustrated in FIG. 8, in the present example embodiment, the outer electrode 124 has a U shape with right-angled corners in front view. However, this is not restrictive, and the outer electrode 124 can have a V shape in front view or a U shape with round corners in front view.

A dimension, in the length direction z, of the multilayer ceramic capacitor 110 including the multilayer body 12, the first outer electrode 124a, and the second outer electrode 124b is referred to as an L dimension, a dimension, in the laminating direction x, of the multilayer ceramic capacitor 110 including the multilayer body 12, the first outer electrode 124a, and the second outer electrode 124b is referred to as a T dimension, and a dimension, in the width direction y, of the multilayer ceramic capacitor 110 including the multilayer body 12, the first outer electrode 124a, and the second outer electrode 124b is referred to as a W dimension.

The dimensions of the multilayer ceramic capacitor 110 are, for example, preferably set so that the L dimension in the length direction z is equal to or greater than about 200 μm and equal to or less than about 900 μm, the W dimension in the width direction y is equal to or greater than about 200 μm and equal to or less than about 900 μm, and the T dimension in the laminating direction x is equal to or greater than about 50 μm and equal to or less than about 300 μm.

The dimension (W dimension) of the multilayer ceramic capacitor 110 in the width direction y is larger than the dimension (L dimension) of the multilayer ceramic capacitor 110 in the length direction z. In other words, the L dimension of the multilayer ceramic capacitor 110 in the length direction z is shorter than the W dimension of the multilayer ceramic capacitor 110 in the width direction y. Since the multilayer ceramic capacitor 110 has an LW reversed type shape as described above, a current path is shortened, and therefore ESL can be made low.

The multilayer ceramic capacitor 110 can effectively produce the advantageous effects of the present invention in a case where a sum (the T dimension) of the thickness of each of the first outer electrode 124a and the second outer electrode 124b disposed on the first main surface 12a and the thickness of the multilayer body 12 in the laminating direction x is, for example, equal to or less than about 80 μm. The advantageous effects are more effective in a case where the T dimension of the multilayer ceramic capacitor 110 in the laminating direction x is, for example, equal to or less than about 55 μm, more preferably equal to or less than about 50 μm.

### C. Third Example Embodiment

### 1. Multilayer Ceramic Capacitor

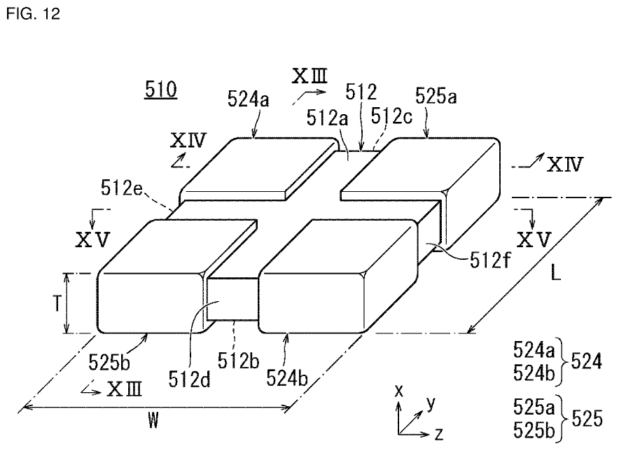

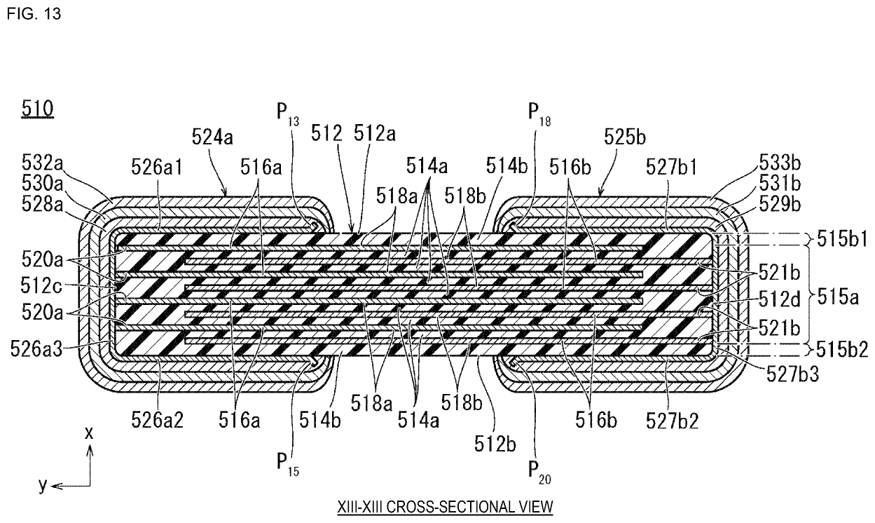

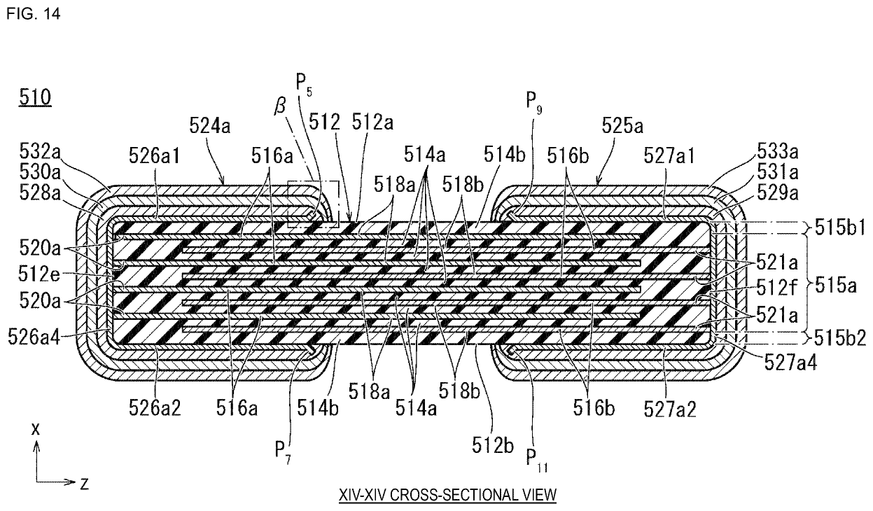

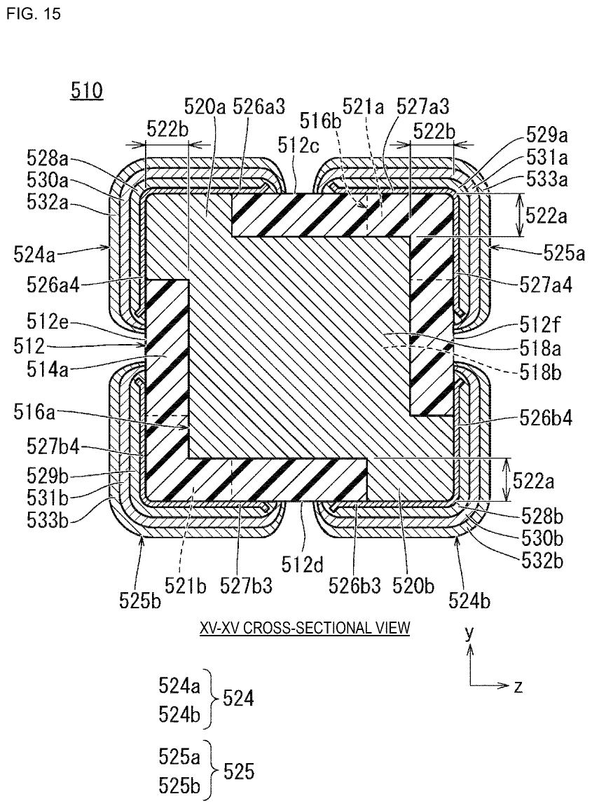

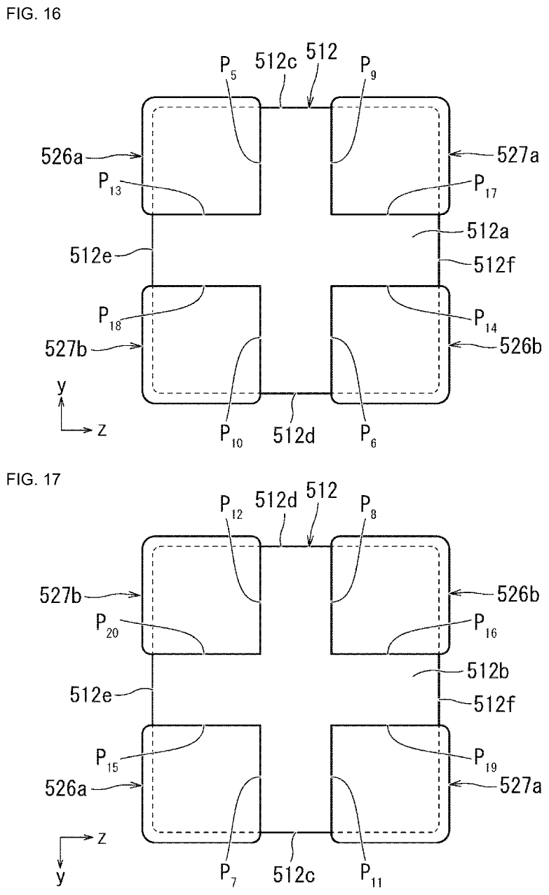

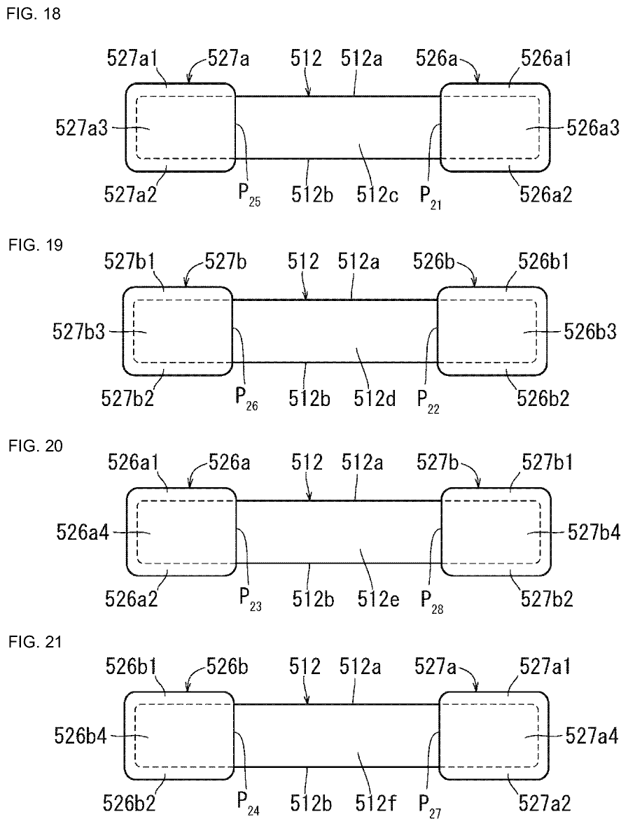

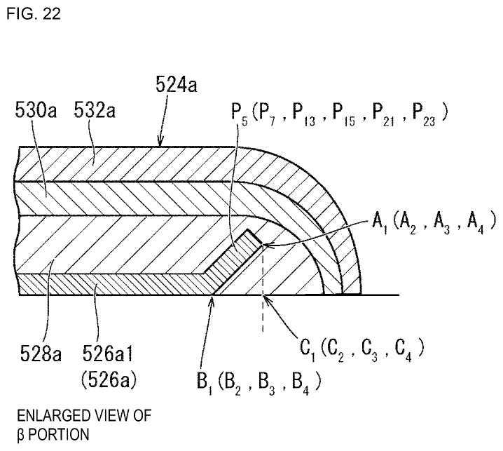

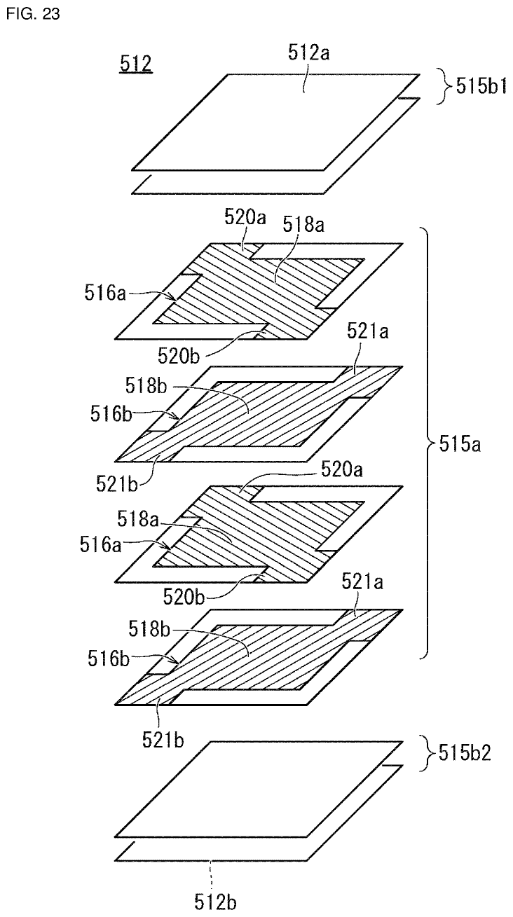

Next, a multilayer ceramic capacitor 510 according to a third example embodiment of the present invention will be described. FIG. 12 is an external perspective view illustrating a multilayer ceramic capacitor according to the third example embodiment of the present invention. FIG. 13 is a cross-sectional view taken along line XIII-XIII in FIG. 12. FIG. 14 is a cross-sectional view taken along line XIV-XIV in FIG. 12. FIG. 15 is a cross-sectional view taken along line XV-XV in FIG. 12. FIG. 16 is a top view illustrating a multilayer body and a thin film layer of the multilayer ceramic capacitor according to the third example embodiment of the present invention. FIG. 17 is a bottom view illustrating the multilayer body and the thin film layer of the multilayer ceramic capacitor according to the third example embodiment of the present invention. FIG. 18 is a front view illustrating the multilayer body and the thin film layer of the multilayer ceramic capacitor according to the third example embodiment of the present invention. FIG. 19 is a back view illustrating the multilayer body and the thin film layer of the multilayer ceramic capacitor according to the third example embodiment of the present invention. FIG. 20 is a left side view illustrating the multilayer body and the thin film layer of the multilayer ceramic capacitor according to the third example embodiment of the present invention. FIG. 21 is a right side view illustrating the multilayer body and the thin film layer of the multilayer ceramic capacitor according to the third example embodiment of the present invention. FIG. 22 is an enlarged view of a β portion in FIG. 13. FIG. 23 is an exploded perspective view of the multilayer body illustrated in FIG. 12.

The multilayer ceramic capacitor 510 includes a multilayer body 512 and outer electrodes 524 and 525.

The multilayer body 512 includes a plurality of laminated dielectric layers 514 and a plurality of laminated internal electrode layers 516. The multilayer body 512 includes a first main surface 512a and a second main surface 512b that are opposed to each other in a laminating direction x, a first side surface 512c and a second side surface 512d that are opposed to each other in a width direction y orthogonal or substantially orthogonal to the laminating direction x, and a third side surface 512e and a fourth side surface 512f that are opposed to each other in a length direction z orthogonal or substantially orthogonal to the laminating direction x and the width direction y. The first main surface 512a and the second main surface 512b extend along the width direction y and the length direction z. The first side surface 512c and the second side surface 512d extend along the laminating direction x and the length direction z. The third side surface 512e and the fourth side surface 512f extend along the laminating direction x and the width direction y. Accordingly, the laminating direction x is a direction connecting the first main surface 512a and the second main surface 512b, the width direction y is a direction connecting the first side surface 512c and the second side surface 512d, and the length direction z is a direction connecting the third side surface 512e and the fourth side surface 512f.

Corner portions and ridge portions of the multilayer body 512 are preferably rounded. The corner portions are portions where three adjacent surfaces of the multilayer body 512 cross, and the ridge portions are portions where adjacent two surfaces of the multilayer body 512 cross.

As illustrated in FIGS. 13 and 14, the multilayer body 512 includes an inner layer portion 515a in which the plurality of internal electrode layers 516 face each other in the laminating direction x connecting the first main surface 512a and the second main surface 512b, a first main-surface-side outer layer portion 515b1 including a plurality of dielectric layers 514 located between an internal electrode layer 516 closest to the first main surface 512a and the first main surface 512a, and a second main-surface-side outer layer portion 515b2 including a plurality of dielectric layers 514 located between an internal electrode layer 516 closest to the second main surface 512b and the second main surface 512b.

The dielectric layers 514 include an inner dielectric layer 514a, which is a dielectric layer 514 of the inner layer portion 515a, and outer dielectric layers 514b, which are dielectric layers 514 of the first main-surface-side outer layer portion 515bl and the second main-surface-side outer layer portion 515b2.

The first main-surface-side outer layer portion 515b1 is a collection of a plurality of outer dielectric layers 514b that are located close to the first main surface 512a of the multilayer body 512 and are located between the first main surface 512a and the internal electrode layer 516 closest to the first main surface 512a.

The second main-surface-side outer layer portion 515b2 is a collection of a plurality of outer dielectric layers 514b that are located close to the second main surface 512b of the multilayer body 512 and are located between the second main surface 512b and the internal electrode layer 516 closest to the second main surface 512b.

The inner layer portion 515a is a region sandwiched between the first main-surface-side outer layer portion 515b1 and the second main-surface-side outer layer portion 515b2. That is, the inner layer portion 515a is a region where the internal electrode layers 516 are laminated.

The inner layer portion 515a includes the inner dielectric layer 514a, a first internal electrode layer 516a that is laminated alternately with the inner dielectric layer 514a, and a second internal electrode layer 516b that is laminated alternately with the inner dielectric layer 514a.

The dielectric layers 514 can include a plurality of crystal grains including, for example, a perovskite compound whose basic structure is BaTiO₃.

The dielectric layers 514 can be, for example, made of a dielectric material. As the dielectric material, for example, dielectric ceramics including BaTiO₃, CaTiO₃, SrTiO₃, CaZrO₃, or the like as a main component may be used, for example. In addition, an accessory component such as, for example, an Mn component, a Fe component, a Cr component, a Co component, or an Ni component may be added to such a main component.

The inner dielectric layer 514a and the outer dielectric layer 514b may be made of different materials in consideration of required functions. For example, use of a soft material for the outer dielectric layers 514b can mitigate stress applied to the multilayer body 512. Use of a solid material for the outer dielectric layers 514b can reduce or prevent the occurrence of a crack.

The first main-surface-side outer layer portion 515b1 and the second main-surface-side outer layer portion 515b2 are each a collection of a plurality of outer dielectric layers 514b. The plurality of outer dielectric layers 514b in each of the first main-surface-side outer layer portion 515bl and the second main-surface-side outer layer portion 515b2 may be integrated after baking and indistinguishable from one another.

The number of laminated dielectric layers 514 is not limited in particular, and is, for example, preferably equal to or greater than 3 and equal to or less than 20 including the first main-surface-side outer layer portion 515bl and the second main-surface-side outer layer portion 515b2. A thickness of each of the dielectric layers 514 is, for example, preferably equal to or greater than about 1 μm and equal to or less than about 6 μm.

As illustrated in FIGS. 13 to 15, the internal electrode layers 516 include a plurality of first internal electrode layers 516a and a plurality of second internal electrode layers 516b. The first internal electrode layers 516a are laminated alternately with the plurality of dielectric layers 514 and are exposed at least on the first side surface 512c and the second side surface 512d. The second internal electrode layers 516b are laminated alternately with the plurality of dielectric layers 514 and are exposed at least on the first side surface 512c and the second side surface 512d. Specifically, the first internal electrode layers 516a and the second internal electrode layers 516b are alternately laminated with the inner dielectric layer 514a interposed therebetween.

Each of the first internal electrode layers 516a is disposed on a surface of the inner dielectric layer 514a. The first internal electrode layers 516a each include a first opposed electrode portion 518a that faces the first main surface 512a and the second main surface 512b and are laminated in a direction connecting the first main surface 512a and the second main surface 512b.

Each of the second internal electrode layers 516b is disposed on a surface of the inner dielectric layer 514a different from the inner dielectric layer 514a on which the first internal electrode layer 516a is disposed. The second internal electrode layers 516b each include a second opposed electrode portion 518b that faces the first main surface 512a and the second main surface 512b and are laminated in the direction connecting the first main surface 512a and the second main surface 512b.

As illustrated in FIGS. 13 to 15, each of the first internal electrode layers 516a is extended to the first side surface 512c and the third side surface 512e of the multilayer body 512 by a first extended electrode portion 520a and is extended to the second side surface 512d and the fourth side surface 512f of the multilayer body 512 by a second extended electrode portion 520b. A width by which the first extended electrode portion 520a is extended to the first side surface 512c may be equal or substantially equal to a width by which the first extended electrode portion 520a is extended to the third side surface 512e, and a width by which the second extended electrode portion 520b is extended to the second side surface 512d may be equal or substantially equal to a width by which the second extended electrode portion 520b is extended to the fourth side surface 512f.

Each of the second internal electrode layers 516b is extended to the first side surface 512c and the fourth side surface 512f of the multilayer body 512 by a third extended electrode portion 521a and is extended to the second side surface 512d and the third side surface 512e of the multilayer body 512 by a fourth extended electrode portion 521b. A width by which the third extended electrode portion 521a is extended to the first side surface 512c may be equal or substantially equal to a width by which the third extended electrode portion 521a is extended to the fourth side surface 512f, and a width by which the fourth extended electrode portion 521b is extended to the second side surface 512d may be equal or substantially equal to a width by which the fourth extended electrode portion 521b is extended to the third side surface 512e.

As illustrated in FIG. 15, the multilayer body 512 includes a side portion (L gap) 522b of the multilayer body 512 that is provided between one end of the first opposed electrode portion 518a in the length direction z and the third side surface 512e and between the other end of the second opposed electrode portion 518b in the length direction z and the fourth side surface 512f.

Furthermore, as illustrated in FIG. 15, the multilayer body 512 includes a side portion (W gap) 522a of the multilayer body 512 that is provided between one end of the first opposed electrode portion 518a in the width direction y and the first side surface 512c and between the other end of the second opposed electrode portion 518b in the width direction y and the second side surface 512d.

The internal electrode layers 516 can be, for example, made of an appropriate conductive material such as a metal such as Ni, Cu, Ag, Pd, or Au or an alloy including one of these metals such as an Ag—Pd alloy.

In a case where the first internal electrode layers 516a and the second internal electrode layers 516b include Sn, for example, a potential barrier height of an interface between the first internal electrode layer 516a and the inner dielectric layer 514a and an interface between the second internal electrode layer 516b and the inner dielectric layer 514a can be increased, and a thickness of a depletion layer can be increased. This can reduce electric field concentration on the interfaces, leading to an improvement of high-temperature load reliability. Even in a case where only the first internal electrode layers 516a or the second internal electrode layers 516b includes Sn, the advantageous effects can be sufficiently produced.

To increase capacitance of the capacitor, the area of the internal electrode layers 516 needs to be increased. It is therefore preferable that LW plane coverage of the internal electrode layers 516 is, for example, equal to or greater than about 90%. The LW plane coverage is defined as a ratio obtained by subtracting an area of a gap from an area of an inside of edge portions of the internal electrode layers 516 viewed from a cross section (LW plane) of the multilayer body 512 in the width direction y and the length direction z. Although the capacitance of the capacitor becomes higher as the LW plane coverage becomes higher, the inner dielectric layers 514a are joined in the gap, and therefore interlayer joint strength is high and interlayer peeling is less likely to occur even in a case where the LW plane coverage is low.

A thickness of each of the internal electrode layers 516, that is, the first internal electrode layers 516a and the second internal electrode layers 516b is, for example, preferably equal to or greater than about 0.3 μm and equal to or less than about 1.0 μm. The total number of first internal electrode layers 516a and second internal electrode layers 516b is, for example, preferably equal to or greater than 20 and equal to or less than 90.

As illustrated in FIG. 12, the outer electrodes 524 and 525 are disposed on the multilayer body 512.

The outer electrode 524 includes a first outer electrode 524a and a second outer electrode 524b.

The first outer electrode 524a covers a portion of the first side surface 512c and a portion of the first main surface 512a of the multilayer body 512. In the present example embodiment, the first outer electrode 524a covers the first extended electrode portion 520a on the first side surface 512c and the third side surface 512e and covers a portion of the first main surface 512a and a portion of the second main surface 512b. The first outer electrode 524a is electrically connected to the first extended electrode portions 520a of the first internal electrode layers 516a.

The second outer electrode 524b covers a portion of the second side surface 512d and a portion of the first main surface 512a of the multilayer body 512. In the present example embodiment, the second outer electrode 524b covers the second extended electrode portion 520b on the second side surface 512d and the fourth side surface 512f and covers a portion of the first main surface 512a and a portion of the second main surface 512b. The second outer electrode 524b is electrically connected to the second extended electrode portions 520b of the first internal electrode layers 516a.

The outer electrode 525 includes a third outer electrode 525a and a fourth outer electrode 525b.

The third outer electrode 525a is spaced away from the first outer electrode 524a and covers a portion of the first side surface 512c and a portion of the first main surface 512a of the multilayer body 512. In the present example embodiment, the third outer electrode 525a covers the third extended electrode portion 521a on the first side surface 512c and the fourth side surface 512f and covers a portion of the first main surface 512a and a portion of the second main surface 512b. The third outer electrode 525a is electrically connected to the third extended electrode portions 521a of the second internal electrode layers 516b.

The fourth outer electrode 525b is spaced away from the second outer electrode 524b and covers a portion of the second side surface 512d and a portion of the first main surface 512a of the multilayer body 512. In the present example embodiment, the fourth outer electrode 525b covers the fourth extended electrode portion 521b on the second side surface 512d and the third side surface 512e and covers a portion of the first main surface 512a and a portion of the second main surface 512b. The fourth outer electrode 525b is electrically connected to the fourth extended electrode portions 521b of the second internal electrode layers 516b.

In the multilayer body 512, the first opposed electrode portion 518a of the first internal electrode layer 516a and the second opposed electrode portion 518b of the second internal electrode layer 516b face each other with the inner dielectric layer 514a interposed therebetween. This generates an electrostatic capacitance. Accordingly, an electrostatic capacitance can be obtained between the first outer electrode 524a and the second outer electrode 524b to which the first internal electrode layers 516a are connected and the third outer electrode 525a and the fourth outer electrode 525b to which the second internal electrode layers 516b are connected, and thus characteristics of the capacitor are provided.

In the present example embodiment, the outer electrodes 524 and 525 are disposed on the first main surface 512a and the second main surface 512b of the multilayer body 512. However, the outer electrodes 524 and 525 need not be disposed on the second main surface 512b, as long as the outer electrodes 524 and 525 are disposed on the first main surface 512a of the multilayer body 512.

The outer electrode 524, that is, each of the first outer electrode 524a and the second outer electrode 524b includes a thin film layer 526 that covers at least a portion of any one or more surfaces of the multilayer body 512, a lower plating layer 528 that covers at least a portion of the thin film layer 526, an upper plating layer 530 that is disposed on the lower plating layer 528, and a front plating layer 532 that is disposed on the upper plating layer 530.

The outer electrode 525, that is, each of the third outer electrode 525a and the fourth outer electrode 525b includes a thin film layer 527 that covers at least a portion of any one or more surfaces of the multilayer body 512, a lower plating layer 529 that covers at least a portion of the thin film layer 527, an upper plating layer 531 that is disposed on the lower plating layer 529, and a front plating layer 533 that is disposed on the upper plating layer 531.

The thin film layer 526 includes a first thin film layer 526a and a second thin film layer 526b.

The first thin film layer 526a includes a first main-surface-side thin film layer 526a1 that covers a portion of the first main surface 512a at a corner portion where the first main surface 512a, the first side surface 512c, and the third side surface 512e of the multilayer body 512 cross, a third main-surface-side thin film layer 526a2 that covers a portion of the second main surface 512b at a corner portion where the second main surface 512b, the first side surface 512c, and the third side surface 512e of the multilayer body 512 cross, a first side-surface-side thin film layer 526a3 that covers a portion of the first side surface 512c at a corner portion where the first main surface 512a, the first side surface 512c, and the third side surface 512e of the multilayer body 512 cross, and a third side-surface-side thin film layer 526a4 that covers a portion of the third side surface 512e at a corner portion where the first main surface 512a, the first side surface 512c, and the third side surface 512e of the multilayer body 512 cross.

The second thin film layer 526b includes a second main-surface-side thin film layer 526b1 that covers a portion of the first main surface 512a at a corner portion where the first main surface 512a, the second side surface 512d, and the fourth side surface 512f of the multilayer body 512 cross, a fourth main-surface-side thin film layer 526b2 that covers a portion of the second main surface 512b at a corner portion where the second main surface 512b, the second side surface 512d, and the fourth side surface 512f of the multilayer body 512 cross, a second side-surface-side thin film layer 526b3 that covers a portion of the second side surface 512d at a corner portion where the first main surface 512a, the second side surface 512d, and the fourth side surface 512f of the multilayer body 512 cross, and a fourth side-surface-side thin film layer 526b4 that covers a portion of the fourth side surface 512f at a corner portion where the first main surface 512a, the second side surface 512d, and the fourth side surface 512f of the multilayer body 512 cross.

The thin film layer 527 includes a third thin film layer 527a and a fourth thin film layer 527b.

The third thin film layer 527a includes a fifth main-surface side thin film layer 527al that covers a portion of the first main surface 512a at a corner portion where the first main surface 512a, the first side surface 512c, and the fourth side surface 512f of the multilayer body 512 cross, a seventh main-surface side thin film layer 527a2 that covers a portion of the second main surface 512b at a corner portion where the second main surface 512b, the first side surface 512c, and the fourth side surface 512f of the multilayer body 512 cross, a fifth side-surface-side thin film layer 527a3 that covers a portion of the first side surface 512c at a corner portion where the first main surface 512a, the first side surface 512c, and the fourth side surface 512f of the multilayer body 512 cross, and a seventh side-surface-side thin film layer 527a4 that covers a portion of the fourth side surface 512f at a corner portion where the first main surface 512a, the first side surface 512c, and the fourth side surface 512f of the multilayer body 512 cross.

The fourth thin film layer 527b includes a sixth main-surface-side thin film layer 527b1 that covers a portion of the first main surface 512a at a corner portion where the first main surface 512a, the second side surface 512d, and the third side surface 512e of the multilayer body 512 cross, an eighth main-surface-side thin film layer 527b2 that covers a portion of the second main surface 512b at a corner portion where the second main surface 512b, the second side surface 512d, and the third side surface 512e of the multilayer body 512 cross, a sixth side-surface-side thin film layer 527b3 that covers a portion of the second side surface 512d at a corner portion where the first main surface 512a, the second side surface 512d, and the third side surface 512e of the multilayer body 512 cross, and an eighth side-surface-side thin film layer 527b4 that covers a portion of the third side surface 512e at a corner portion where the first main surface 512a, the second side surface 512d, and the third side surface 512e of the multilayer body 512 cross.

An end edge portion P₅ of the first main-surface-side thin film layer 526a1 that is located adjacent to a center of the multilayer body 512 in the length direction z is spaced apart from the multilayer body 512 in the laminating direction x. That is, the end edge portion P₅ of the first main-surface-side thin film layer 526a1 that is located adjacent to the center of the multilayer body 512 in the length direction z is floating above the multilayer body 512. Since the end edge portion P₅ of the first main-surface-side thin film layer 526a1 is continuously floating in the width direction y, tensile stress applied to the end edge portion P₅ of the first main-surface-side thin film layer 526a1 can be maintained small even upon application of thermal stress. This can reduce or prevent the occurrence of a crack in the multilayer body 512 caused by thermal stress.

Among positions of the end edge portion P₅ of the first main-surface-side thin film layer 526a1 that is located adjacent to the center of the multilayer body 512 in the length direction z, a position of the first main-surface-side thin film layer 526a1 that is closest in the length direction z to the center of the multilayer body 512 in the length direction z is referred to as a position A₁, a position at which the first main-surface-side thin film layer 526a1 starts to be spaced apart from the multilayer body 512 in the laminating direction x is referred to as a position B₁, and a position at which a perpendicular or substantially perpendicular line extending from the position A₁ in the laminating direction x crosses the multilayer body 512 is referred to as a position C₁. It is preferable that ∠A₁B₁C₁ is, for example, equal to or greater than about 20 degrees and equal to or less than about 70 degrees. By using the numerical range, the end edge portion P₅ of the first main-surface-side thin film layer 526a1 that is located adjacent to the center of the multilayer body 512 in the length direction z is sufficiently spaced apart from the multilayer body 512, and a distance from the position B₁ to the position C₁ in the length direction z can be made sufficient. Accordingly, a direction of compressive stress can be sufficiently changed. As a result, tensile stress applied to the end edge portion P₅ of the first main-surface-side thin film layer 526a1 can be maintained small even upon application of thermal stress. This can reduce or prevent the occurrence of a crack in the multilayer body 512 caused by thermal stress.

A distance from the position A₁ to the position B₁ in the length direction z is, for example, preferably equal to or greater than about 5 μm and equal to or less than about 20 μm. Accordingly, the distance from the position A₁ to the position B₁ can be made sufficient, and therefore the direction of the compressive stress can be sufficiently changed. On the other hand, in a case where the distance from the position A₁ to the position B₁ in the length direction z is less than about 5 μm, the end edge portion P₅ of the first main-surface-side thin film layer 526a1 that is located adjacent to the center of the multilayer body 512 in the length direction z cannot be sufficiently spaced apart from the multilayer body 512. In a case where the distance from the position A₁ to the position B₁ in the length direction z is larger than about 20 μm, a crack may undesirably occur in the multilayer body 512 due to excessive stress of the first main-surface-side thin film layer 526a1.

Similarly, an end edge portion P₆ of the second main-surface-side thin film layer 526b1 that is located adjacent to the center of the multilayer body 512 in the length direction z is spaced apart t from the multilayer body 512 in the laminating direction x. That is, the end edge portion P₆ of the second main-surface-side thin film layer 526b1 that is located adjacent to the center of the multilayer body 512 in the length direction z is floating above the multilayer body 512.

An end edge portion P₇ of the third main-surface-side thin film layer 526a2 that is located adjacent to the center of the multilayer body 512 in the length direction z is spaced apart from the multilayer body 512 in the laminating direction x. That is, the end edge portion P₇ of the third main-surface-side thin film layer 526a2 that is located adjacent to the center of the multilayer body 512 in the length direction z is floating above the multilayer body 512.

An end edge portion P₈ of the fourth main-surface-side thin film layer 526b2 that is located adjacent to the center of the multilayer body 512 in the length direction z is spaced apart from the multilayer body 512 in the laminating direction x. That is, the end edge portion P₈ of the fourth main-surface-side thin film layer 526b2 that is located adjacent to the center of the multilayer body 512 in the length direction z is floating above the multilayer body 512.

An end edge portion P₉ of the fifth main-surface side thin film layer 527al that is located adjacent to the center of the multilayer body 512 in the length direction z is spaced apart from the multilayer body 512 in the laminating direction x. That is, the end edge portion P₉ of the fifth main-surface side thin film layer 527al that is located adjacent to the center of the multilayer body 512 in the length direction z is floating above the multilayer body 512.

An end edge portion P₁₀ of the sixth main-surface-side thin film layer 527b1 that is located adjacent to the center of the multilayer body 512 in the length direction z is spaced apart from the multilayer body 512 in the laminating direction x. That is, the end edge portion P₁₀ of the sixth main-surface-side thin film layer 527b1 that is located adjacent to the center of the multilayer body 512 in the length direction z is floating above the multilayer body 512.

An end edge portion Pu of the seventh main-surface side thin film layer 527a2 that is located adjacent to the center of the multilayer body 512 in the length direction z is spaced apart from the multilayer body 512 in the laminating direction x. That is, the end edge portion Pu of the seventh main-surface side thin film layer 527a2 that is located adjacent to the center of the multilayer body 512 in the length direction z is floating above the multilayer body 512.

An end edge portion P₁₂ of the eighth main-surface-side thin film layer 527b2 that is located adjacent to the center of the multilayer body 512 in the length direction z is spaced apart from the multilayer body 512 in the laminating direction x. That is, the end edge portion P₁₂ of the eighth main-surface-side thin film layer 527b2 that is located adjacent to the center of the multilayer body 512 in the length direction z is floating above the multilayer body 512.

As for the second main-surface-side thin film layer 526b1, the third main-surface-side thin film layer 526a2, the fourth main-surface-side thin film layer 526b2, the fifth main-surface side thin film layer 527a1, the sixth main-surface-side thin film layer 527b1, the seventh main-surface side thin film layer 527a2, and the eighth main-surface-side thin film layer 527b2, the end edge portion P₆, P₇, P₈, P₉, P₁₀, P₁₁, and P₁₂ are continuously floating in the width direction y, and therefore tensile stress applied to the end edge portions P₆, P₇, P₈, P₉, P₁₀, P₁₁, and P₁₂ can be maintained small even upon application of thermal stress, as with the first main-surface-side thin film layer 526al. This can reduce or prevent the occurrence of a crack in the multilayer body 512 caused by thermal stress.

An end edge portion P₁₃ of the first main-surface-side thin film layer 526a1 that is located adjacent to the center of the multilayer body 512 in the width direction y is spaced apart from the multilayer body 512 in the laminating direction x. That is, the end edge portion P₁₃ of the first main-surface-side thin film layer 526a1 that is located adjacent to the center of the multilayer body 512 in the width direction y is floating above the multilayer body 512. Since the end edge portion P₁₃ of the first main-surface-side thin film layer 526a1 is continuously floating in the length direction z, tensile stress applied to the end edge portion P₁₃ of the first main-surface-side thin film layer 526a1 can be maintained small even upon application of thermal stress. This can reduce or prevent the occurrence of a crack in the multilayer body 512 caused by thermal stress.

Among positions of the end edge portion P₁₃ of the first main-surface-side thin film layer 526a1 that is located adjacent to the center of the multilayer body 512 in the width direction y, a position of the first main-surface-side thin film layer 526a1 that is closest in the width direction y to the center of the multilayer body 512 in the width direction y is referred to as a position A₂, a position at which the first main-surface-side thin film layer 526a1 starts to be spaced apart from the multilayer body 512 in the laminating direction x is referred to as a position B₂, and a position at which a perpendicular or substantially perpendicular line extending from the position A₂ in the laminating direction x crosses the multilayer body 512 is referred to as a position C₂. It is preferable that ∠A₂B₂C₂ is, for example, equal to or greater than about 20 degrees and equal to or less than about 70 degrees. By using the numerical range, the end edge portion P₁₃ of the first main-surface-side thin film layer 526a1 that is located adjacent to the center of the multilayer body 512 in the width direction y is sufficiently spaced apart from the multilayer body 512, and a distance from the position Be to the position C₂ in the width direction y can be made sufficient. Accordingly, a direction of compressive stress can be sufficiently changed. As a result, tensile stress applied to the end edge portion P₁₃ of the first main-surface-side thin film layer 526a1 can be maintained small even upon application of thermal stress. This can reduce or prevent the occurrence of a crack in the multilayer body 512 caused by thermal stress.

A distance from the position A₂ to the position Be in the width direction y is, for example, preferably equal to or greater than about 5 μm and equal to or less than about 20 μm. Accordingly, the distance from the position A₂ to the position B₂ can be made sufficient, and therefore the direction of the compressive stress can be sufficiently changed. On the other hand, in a case where the distance from the position A₂ to the position B₂ in the width direction y is less than about 5 μm, the end edge portion P₁₃ of the first main-surface-side thin film layer 526a1 that is located adjacent to the center of the multilayer body 512 in the width direction y cannot be sufficiently spaced apart from the multilayer body 512. In a case where the distance from the position A₂ to the position B₂ in the width direction y is larger than about 20 μm, a crack may undesirably occur in the multilayer body 512 due to excessive stress of the first main-surface-side thin film layer 526a1.

Similarly, an end edge portion P₁₄ of the second main-surface-side thin film layer 526b1 that is located adjacent to the center of the multilayer body 512 in the width direction y is spaced apart from the multilayer body 512 in the laminating direction x. That is, the end edge portion P₁₄ of the second main-surface-side thin film layer 526b1 that is located adjacent to the center of the multilayer body 512 in the width direction y is floating above the multilayer body 512.

An end edge portion P₁₅ of the third main-surface-side thin film layer 526a2 that is located adjacent to the center of the multilayer body 512 in the width direction y is spaced apart from the multilayer body 512 in the laminating direction x. That is, the end edge portion P₁₅ of the third main-surface-side thin film layer 526a2 that is located adjacent to the center of the multilayer body 512 in the width direction y is floating above the multilayer body 512.

An end edge portion P₁₆ of the fourth main-surface-side thin film layer 526b2 that is located adjacent to the center of the multilayer body 512 in the width direction y is spaced apart from the multilayer body 512 in the laminating direction x. That is, the end edge portion P₁₆ of the fourth main-surface-side thin film layer 526b2 that is located adjacent to the center of the multilayer body 512 in the width direction y is floating above the multilayer body 512.

An end edge portion Piz of the fifth main-surface side thin film layer 527al that is located adjacent to the center of the multilayer body 512 in the width direction y is spaced apart from the multilayer body 512 in the laminating direction x. That is, the end edge portion P₁₇ of the fifth main-surface side thin film layer 527al that is located adjacent to the center of the multilayer body 512 in the width direction y is floating above the multilayer body 512.

An end edge portion P₁₈ of the sixth main-surface-side thin film layer 527b1 that is located adjacent to the center of the multilayer body 512 in the width direction y is spaced apart from the multilayer body 512 in the laminating direction x. That is, the end edge portion P₁₈ of the sixth main-surface-side thin film layer 527b1 that is located adjacent to the center of the multilayer body 512 in the width direction y is floating above the multilayer body 512.

An end edge portion P₁₉ of the seventh main-surface side thin film layer 527a2 that is located adjacent to the center of the multilayer body 512 in the width direction y is spaced apart from the multilayer body 512 in the laminating direction x. That is, the end edge portion P₁₉ of the seventh main-surface side thin film layer 527a2 that is located adjacent to the center of the multilayer body 512 in the width direction y is floating above the multilayer body 512.

An end edge portion P₂₀ of the eighth main-surface-side thin film layer 527b2 that is located adjacent to the center of the multilayer body 512 in the width direction y is spaced apart from the multilayer body 512 in the laminating direction x. That is, the end edge portion P₂₀ of the eighth main-surface-side thin film layer 527b2 that is located adjacent to the center of the multilayer body 512 in the width direction y is floating above the multilayer body 512.

As for the second main-surface-side thin film layer 526b1, the third main-surface-side thin film layer 526a2, the fourth main-surface-side thin film layer 526b2, the fifth main-surface side thin film layer 527al, the sixth main-surface-side thin film layer 527b1, the seventh main-surface side thin film layer 527a2, and the eighth main-surface-side thin film layer 527b2, the end edge portion P₁₄, P₁₅, P₁₆, P₁₇, P₁₈, P₁₉, and P₂₀ are continuously floating in the length direction z, and therefore tensile stress applied to the end edge portion P₁₄, P₁₅, P₁₆, P₁₇, P₁₈, P₁₉, and Pro can be maintained small even upon application of thermal stress, as with the first main-surface-side thin film layer 526a1. This can reduce or prevent the occurrence of a crack in the multilayer body 512 caused by thermal stress.

An end edge portion Pa of the first side-surface-side thin film layer 526a3 that is located adjacent to the center of the multilayer body 512 in the length direction z is spaced apart from the multilayer body 512 in the width direction y. That is, the end edge portion Pai of the first side-surface-side thin film layer 526a3 that is located adjacent to the center of the multilayer body 512 in the length direction z is floating above the multilayer body 512. Since the end edge portion P₂₁ of the first side-surface-side thin film layer 526a3 is continuously floating in the laminating direction x, tensile stress applied to the end edge portion Pai of the first side-surface-side thin film layer 526a3 can be maintained small even upon application of thermal stress. This can reduce or prevent the occurrence of a crack in the multilayer body 512 caused by thermal stress.

Among positions of the end edge portion Pai of the first side-surface-side thin film layer 526a3 that is located adjacent to the center of the multilayer body 512 in the length direction z, a position of the first side-surface-side thin film layer 526a3 that is closest in the length direction z to the center of the multilayer body 512 in the length direction z is referred to as a position A₃, a position at which the first side-surface-side thin film layer 526a3 starts to be spaced apart from the multilayer body 512 in the width direction y is referred to as a position B₃, and a position at which a perpendicular or substantially perpendicular line extending from the position A₃ in the width direction y crosses the multilayer body 512 is referred to as a position C₃. It is preferable that ∠A₃B₃C₃ is, for example, equal to or greater than about 20 degrees and equal to or less than about 70 degrees. By using the numerical range, the end edge portion P₂₁ of the first side-surface-side thin film layer 526a3 that is located adjacent to the center of the multilayer body 512 in the length direction z is sufficiently spaced apart from the multilayer body 512, and a distance from the position B₃ to the position C₃ in the length direction z can be made sufficient. Accordingly, a direction of compressive stress can be sufficiently changed. As a result, tensile stress applied to the end edge portion Pai of the first side-surface-side thin film layer 526a3 can be maintained small even upon application of thermal stress. This can reduce or prevent the occurrence of a crack in the multilayer body 512 caused by thermal stress.

A distance from the position A₃ to the position B₃ in the length direction z is, for example, preferably equal to or greater than about 5 μm and equal to or less than about 20 μm. Accordingly, the distance from the position A₃ to the position B₃ can be made sufficient, and therefore the direction of the compressive stress can be sufficiently changed. On the other hand, in a case where the distance from the position A₃ to the position B₃ in the length direction z is less than about 5 μm, the end edge portion P₂₁ of the first side-surface-side thin film layer 526a3 that is located adjacent to the center of the multilayer body 512 in the length direction z cannot be sufficiently spaced apart from the multilayer body 512. In a case where the distance from the position A₃ to the position B₃ in the length direction z is larger than about 20 μm, a crack may undesirably occur in the multilayer body 512 due to excessive stress of the first side-surface-side thin film layer 526a3.

Similarly, an end edge portion P₂₂ of the second side-surface-side thin film layer 526b3 that is located adjacent to the center of the multilayer body 512 in the length direction z is spaced apart from the multilayer body 512 in the width direction y. That is, the end edge portion P₂₂ of the second side-surface-side thin film layer 526b3 that is located adjacent to the center of the multilayer body 512 in the length direction z is floating above the multilayer body 512.

An end edge portion P₂₅ of the fifth side-surface-side thin film layer 527a3 that is located adjacent to the center of the multilayer body 512 in the length direction z is spaced apart from the multilayer body 512 in the width direction y. That is, the end edge portion P₂₅ of the fifth side-surface-side thin film layer 527a3 that is located adjacent to the center of the multilayer body 512 in the length direction z is floating above the multilayer body 512.

An end edge portion P₂₆ of the sixth side-surface-side thin film layer 527b3 that is located adjacent to the center of the multilayer body 512 in the length direction z is spaced apart from the multilayer body 512 in the width direction y. That is, the end edge portion P₂₆ of the sixth side-surface-side thin film layer 527b3 that is located adjacent to the center of the multilayer body 512 in the length direction z is floating above the multilayer body 512.

As for the second side-surface-side thin film layer 526b3, the fifth side-surface-side thin film layer 527a3, and the sixth side-surface-side thin film layer 527b3, the end edge portions P₂₂, P₂₅, and P₂₆ are continuously floating in the laminating direction x, and therefore tensile stress applied to the end edge portion P₂₂, P₂₅, and P₂₆ can be maintained small even upon application of thermal stress, as with first side-surface-side thin film layer 526a3. This can reduce or prevent the occurrence of a crack in the multilayer body 512 caused by thermal stress.

An end edge portion P₂₃ of the third side-surface-side thin film layer 526a4 that is located adjacent to the center of the multilayer body 512 in the width direction y is spaced apart from the multilayer body 512 in the length direction z. That is, the end edge portion P₂₃ of the third side-surface-side thin film layer 526a4 that is located adjacent to the center of the multilayer body 512 in the width direction y is floating above the multilayer body 512. Since the end edge portion P₂₃ of the third side-surface-side thin film layer 526a4 is continuously floating in the laminating direction x, tensile stress applied to the end edge portion P₂₃ of the third side-surface-side thin film layer 526a4 can be maintained small even upon application of thermal stress. This can reduce or prevent the occurrence of a crack in the multilayer body 512 caused by thermal stress.

Among positions of the end edge portion P₂₃ of the third side-surface-side thin film layer 526a4 that is located adjacent to the center of the multilayer body 512 in the width direction y, a position of the third side-surface-side thin film layer 526a4 that is closest in the width direction y to the center of the multilayer body 512 in the width direction y is referred to as a position A₄, a position at which the third side-surface-side thin film layer 526a4 starts to be spaced apart from the multilayer body 512 in the length direction z is referred to as a position B₄, and a position at which a perpendicular or substantially perpendicular line extending from the position A₄ in the length direction z crosses the multilayer body 512 is referred to as a position C₄. It is preferable that ∠A₄B₄C₄ is, for example, equal to or greater than about 20 degrees and equal to or less than about 70 degrees. By using the numerical range, the end edge portion P₂₃ of the third side-surface-side thin film layer 526a4 that is located adjacent to the center of the multilayer body 512 in the width direction y is sufficiently spaced apart from the multilayer body 512, and a distance from the position B₄ to the position C₄ in the width direction y can be made sufficient. Accordingly, a direction of compressive stress can be sufficiently changed. As a result, tensile stress applied to the end edge portion P₂₃ of the third side-surface-side thin film layer 526a4 can be maintained small even upon application of thermal stress. This can reduce or prevent the occurrence of a crack in the multilayer body 512 caused by thermal stress.

A distance from the position A₄ to the position B₄ in the width direction y is, for example, preferably equal to or greater than about 5 μm and equal to or less than about 20 μm. Accordingly, the distance from the position A₄ to the position B₄ can be made sufficient, and therefore the direction of the compressive stress can be sufficiently changed. On the other hand, in a case where the distance from the position A₄ to the position B₄ in the width direction y is less than about 5 μm, the end edge portion P₂₃ of the third side-surface-side thin film layer 526a4 that is located adjacent to the center of the multilayer body 512 in the width direction y cannot be sufficiently spaced apart from the multilayer body 512. In a case where the distance from the position A₄ to the position B₄ in the width direction y is larger than about 20 μm, a crack may undesirably occur in the multilayer body 512 due to excessive stress of the third side-surface-side thin film layer 526a4.

Similarly, an end edge portion P₂₄ of the fourth side-surface-side thin film layer 526b4 that is located adjacent to the center of the multilayer body 512 in the width direction y is spaced apart from the multilayer body 512 in the length direction z. That is, the end edge portion P₂₄ of the fourth side-surface-side thin film layer 526b4 that is located adjacent to the center of the multilayer body 512 in the width direction y is floating above the multilayer body 512.

An end edge portion P₂₇ of the seventh side-surface-side thin film layer 527a4 that is located adjacent to the center of the multilayer body 512 in the width direction y is spaced apart from the multilayer body 512 in the length direction z. That is, the end edge portion P₂₇ of the seventh side-surface-side thin film layer 527a4 that is located adjacent to the center of the multilayer body 512 in the width direction y is floating above the multilayer body 512.

An end edge portion P₂₈ of the eighth side-surface-side thin film layer 527b4 that is located adjacent to the center of the multilayer body 512 in the width direction y is spaced apart from the multilayer body 512 in the length direction z. That is, the end edge portion P₂₈ of the eighth side-surface-side thin film layer 527b4 that is located adjacent to the center of the multilayer body 512 in the width direction y is floating above the multilayer body 512.

As for the fourth side-surface-side thin film layer 526b4, the seventh side-surface-side thin film layer 527a4, and the eighth side-surface-side thin film layer 527b4, the end edge portions P₂₄, P₂₇, and P₂₈ are continuously floating in the laminating direction x, and therefore tensile stress applied to the end edge portions P₂₄, P₂₇, and P₂₈ can be maintained small even upon application of thermal stress, as with the third side-surface-side thin film layer 526a4. This can reduce or prevent the occurrence of a crack in the multilayer body 512 caused by thermal stress.

In the present example embodiment, the thin film layers 526 and 527 are disposed on the first main surface 512a, the second main surface 512b, the first side surface 512c, the second side surface 512d, the third side surface 512e, and the fourth side surface 512f of the multilayer body 512, and the end edge portions P₄ to P₂₈ of the thin film layers 526 and 527 that are located adjacent to the center of the multilayer body 512 are spaced apart from the multilayer body 512. By thus providing the thin film layers 526 and 527, a direction of compressive stress can be changed. This can reduce or prevent the occurrence of a crack in the multilayer body 512 caused by thermal stress.

In a case where the thin film layers 526 and 527 are disposed on the first main surface 512a and/or the second main surface 512b of the multilayer body 512, at least one of the end edge portions of the thin film layers 526 and 527 that face in the length direction z of the multilayer body 512 and at least one of the end edge portions of the thin film layers 526 and 527 that face in the width direction y only need to be spaced apart from the multilayer body 512 among the end edge portions that are located adjacent to the center of the multilayer body 512 and are included in the thin film layers 526 and 527 disposed on the first main surface 512a and/or the second main surface 512b.

In a case where the thin film layers 526 and 527 are disposed on the first side surface 512c and/or the second side surface 512d of the multilayer body 512, at least one of the end edge portions of the thin film layers 526 and 527 that face in the length direction z of the multilayer body 512 only needs to be spaced apart from the multilayer body 512 among the end edge portions that are located adjacent to the center of the multilayer body 512 and are included in the thin film layers 526 and 527 disposed on the first side surface 512c and/or the second side surface 512d.

In a case where the thin film layers 526 and 527 are disposed on the third side surface 512e and/or the fourth side surface 512f of the multilayer body 512, at least one of the end edge portions of the thin film layers 526 and 527 that face in the width direction y of the multilayer body 512 only needs to be spaced apart from the multilayer body 512 among the end edge portions that are located adjacent to the center of the multilayer body 512 and are included in the thin film layers 526 and 527 disposed on the third side surface 512e and/or the fourth side surface 512f.

In a case where the thin film layers 526 and 527 are disposed continuously on the first main surface 512a and/or the second main surface 512b and on the first side surface 512c, the second side surface 512d, the third side surface 512e, and/or the fourth side surface 512f of the multilayer body 512, at least one of the end edge portions adjacent to the center of the multilayer body 512 in the width direction y or at least one of the end edge portions located adjacent to the center in the length direction z of the thin film layers 526 and 527 that are disposed continuously on the first main surface 512a, the second main surface 512b, the first side surface 512c, the second side surface 512d, the third side surface 512e, and/or the fourth side surface 512f only needs to be spaced apart from the multilayer body 512.

The thin film layers 526 and 527 are preferably connected to the internal electrode layers 516. In a case where the thin film layers 526 and 527 and the internal electrode layers 516 are connected, a surface area of a conductive component on each of the side surface 512c, 512d, 512e, and 512f of the multilayer body 512 increases. This can improve contact between the outer electrodes 524 and 525 and the internal electrode layers 516.

The thin film layers 526 and 527 are formed by depositing metal particles. The thin film layers 526 and 527 are preferably formed by a thin film formation method such as, for example, a sputtering method, a vapor deposition method, a chemical vapor deposition (CVD) method, or an atomic layer deposition (ALD) method. By thus forming the thin film layers 526 and 527, a thickness of the thin film layers 526 and 527 in the laminating direction x can be, for example, made equal to or less than about 1.0 μm. Accordingly, a thickness of the multilayer ceramic capacitor 510 in the laminating direction x can be made small. The thin film layers 526 and 527 may be formed by, for example, screen printing or the like.

The thickness of the thin film layers 526 and 527 can be, for example, calculated from a concentration of a predetermined element by performing a calibration curve method on a target metal species by using a fluorescence X-ray analyzer. Alternatively, the thickness and the like can be measured from an actual observation image of a component cross section obtained by a focused ion beam (FIB) by using a scanning electron microscope.

The thin film layers 526 and 527 provided on the first main surface 512a or the second main surface 512b of the multilayer body 512 and the thin film layers 526 and 527 provided on the first side surface 512c, the second side surface 512d, the third side surface 512e, or the fourth side surface 512f of the multilayer body 512 may be connected or may be discontinuous at a ridge portion.

The thin film layers 526 and 527 may include, for example, ceramics and a metal component. In a case where the thin film layers 526 and 527 include ceramics and a metal component, the thin film layers 526 and 527 and the dielectric ceramics included in the dielectric layers 514 of the multilayer body 512 are fixed. This can further improve fixing strength between the multilayer body 512 and the outer electrodes 524 and 525.

The metal component of the thin film layers 526 and 527 is preferably one that includes, for example, Cu or Ni as a main component mixed with about 1 vol % of Cr, V, Ti, Co, or Mn.

A particle size of the metal component of the thin film layers 526 and 527 is preferably, for example, equal to or less than about 1.0 μm. By setting the particle size of the metal component of the thin film layers 526 and 527 small, compressive stress of the entire thin film layers 526 and 527 can be made small.

To measure the particle size of the metal component of the thin film layers 526 and 527, for example, a WT cross section at a position of about ½ of the thin film layers 526 and 527 in the length direction z, an LT cross section at a position of about ½ of the thin film layers 526 and 527 in the width direction y, or an LW cross section at a position of about ½ of the thin film layers 526 and 527 in the laminating direction x is exposed, and the cross section of the thin film layers 526 and 527 is observed by an electronic microscope. A magnification is, for example, preferably about 20000 or more. Ten lines are drawn on an observed surface, which is the cross section of the thin film layers 526 and 527, at equal or substantially equal intervals in the laminating direction x, maximum particle sizes of metal particles on the lines are measured, and an average of the maximum particle sizes is calculated as the particle size.

In a case where the thin film layers 526 and 527 include ceramics, the WT cross section at the position of about ½ of the thin film layers 526 and 527 in the length direction z, the LT cross section at the position of about ½ of the thin film layers 526 and 527 in the width direction y, or the LW cross section at the position of about ½ of the thin film layers 526 and 527 in the laminating direction x is exposed, and a photograph of the cross section is acquired by using a digital microscope (VHX-5000 produced by Keyence Corporation). The thickness can be calculated from the photograph of the cross section. Alternatively, the thickness and the like can be measured from an actual observation image of a component cross section obtained by a focused ion beam (FIB) by using a scanning electron microscope.

A thickness of the thin film layers 526 and 527 in the laminating direction x is, for example, preferably equal to or greater than about 50 nm and equal to or less than about 500 nm.

The lower plating layer 528 includes a first lower plating layer 528a and a second lower plating layer 528b. The lower plating layer 528 is provided so as to be in between the multilayer body 512 and the thin film layer 526.

The first lower plating layer 528a covers the first main-surface-side thin film layer 526a1 disposed on the first main surface 512a, the third main-surface-side thin film layer 526a2 disposed on the second main surface 512b, the first side-surface-side thin film layer 526a3 disposed on the first side surface 512c, and the third side-surface-side thin film layer 526a4 disposed on the third side surface 512e.

The second lower plating layer 528b covers the second main-surface-side thin film layer 526bl disposed on the first main surface 512a, the fourth main-surface-side thin film layer 526b2 disposed on the second main surface 512b, the second side-surface-side thin film layer 526b3 disposed on the second side surface 512d, and the fourth side-surface-side thin film layer 526b4 disposed on the fourth side surface 512f.

The lower plating layer 529 includes a third lower plating layer 529a and a fourth lower plating layer 529b. The lower plating layer 529 is provided so as to be in between the multilayer body 512 and the thin film layer 527.

The third lower plating layer 529a covers the fifth main-surface side thin film layer 527al disposed on the first main surface 512a, the seventh main-surface side thin film layer 527a2 disposed on the second main surface 512b, the fifth side-surface-side thin film layer 527a3 disposed on the first side surface 512c, and the seventh side-surface-side thin film layer 527a4 disposed on the fourth side surface 512f.

The fourth lower plating layer 529b covers the sixth main-surface-side thin film layer 527b1 disposed on the first main surface 512a, the eighth main-surface-side thin film layer 527b2 disposed on the second main surface 512b, the sixth side-surface-side thin film layer 527b3 disposed on the second side surface 512d, and the eighth side-surface-side thin film layer 527b4 disposed on the third side surface 512e.

In the present example embodiment, the lower plating layers 528 and 529 are, for example, Cu plating layers. In a case where the lower plating layers 528 and 529 are Cu plating layers and cover surfaces of the thin film layers 526 and 527, an advantageous effect of reducing or preventing intrusion of a plating solution is produced.

A thickness of the lower plating layers 528 and 529 in the laminating direction x is, for example, preferably equal to or greater than about 50 nm and equal to or less than about 500 nm.

The upper plating layer 530 includes a first upper plating layer 530a and a second upper plating layer 530b.

The first upper plating layer 530a covers the first lower plating layer 528a. Specifically, the first upper plating layer 530a is preferably disposed on a surface of the first lower plating layer 528a disposed on the first side surface 512c and the third side surface 512e and extends to a surface of the first lower plating layer 528a disposed on the first main surface 512a and the second main surface 512b.

The second upper plating layer 530b covers the second lower plating layer 528b. Specifically, the second upper plating layer 530b is preferably disposed on a surface of the second lower plating layer 528b disposed on the second side surface 512d and the fourth side surface 512f and extends to a surface of the second lower plating layer 528b disposed on the first main surface 512a and the second main surface 512b.

The upper plating layer 531 includes a third upper plating layer 531a and a fourth upper plating layer 531b.

The third upper plating layer 531a covers the third lower plating layer 529a. Specifically, the third upper plating layer 531a is preferably disposed on a surface of the third lower plating layer 529a disposed on the first side surface 512c and the fourth side surface 512f and extends to a surface of the third lower plating layer 529a disposed on the first main surface 512a and the second main surface 512b.

The fourth upper plating layer 531b covers the fourth lower plating layer 529b. Specifically, the fourth upper plating layer 531b is preferably disposed on a surface of the fourth lower plating layer 529b disposed on the second side surface 512d and the third side surface 512e and extends to a surface of the fourth lower plating layer 529b disposed on the first main surface 512a and the second main surface 512b.

The upper plating layers 530 and 531 are, for example, preferably Ni plating layers having a solder barrier effect. In the present example embodiment, the upper plating layers 530 and 531 are, for example, Ni plating layers.

A thickness of the upper plating layers 530 and 531 in the laminating direction x is, for example, preferably equal to or greater than about 1 μm and equal to or less than about 9 μm.

The front plating layer 532 includes a first front plating layer 532a and a second front plating layer 532b.

The first front plating layer 532a covers the first upper plating layer 530a. Specifically, the first front plating layer 532a is preferably disposed on a surface of the first upper plating layer 530a disposed on the first side surface 512c and the third side surface 512e and extends to a surface of the first upper plating layer 530a disposed on the first main surface 512a and the second main surface 512b.

The second front plating layer 532b covers the second upper plating layer 530b. Specifically, the second front plating layer 532b is preferably disposed on a surface of the second upper plating layer 530b disposed on the second side surface 512d and the fourth side surface 512f and extends to a surface of the second upper plating layer 530b disposed on the first main surface 512a and the second main surface 512b.

The front plating layer 533 includes a third front plating layer 533a and a fourth front plating layer 533b.

The third front plating layer 533a covers the third upper plating layer 531a. Specifically, the third front plating layer 533a is preferably disposed on a surface of the third upper plating layer 531a disposed on the first side surface 512c and the fourth side surface 512f and extends to a surface of the third upper plating layer 531a disposed on the first main surface 512a and the second main surface 512b.

The fourth front plating layer 533b covers the fourth upper plating layer 531b. Specifically, the fourth front plating layer 533b is preferably disposed on a surface of the fourth upper plating layer 531b disposed on the second side surface 512d and the third side surface 512e and extends to a surface of the fourth upper plating layer 531b disposed on the first main surface 512a and the second main surface 512b.

The front plating layers 532 and 533 can be, for example, Sn plating layers having good joinability with solder, Cu plating layers in view of demands for being embedded in a substrate, or the like, but is not limited to this.

A thickness of the front plating layers 532 and 533 in the laminating direction x is, for example, preferably equal to or greater than about 1 μm and equal to or less than about 7 μm.

A dimension, in the length direction z, of the multilayer ceramic capacitor 510 including the multilayer body 512 and the outer electrodes 524 and 525 is referred to as an L dimension, a dimension, in the laminating direction x, of the multilayer ceramic capacitor 510 including the multilayer body 512 and the outer electrodes 524 and 525 is referred to as a T dimension, and a dimension, in the width direction y, of the multilayer ceramic capacitor 510 including the multilayer body 512 and the outer electrodes 524 and 525 is referred to as a W dimension.

The dimensions of the multilayer ceramic capacitor 510 are, for example, preferably set so that about 7/10≤L/W≤about 10/7. The multilayer body 512 thus has a tetragonal or substantially tetragonal shape, and therefore a degree of freedom of mounting is improved.

The multilayer ceramic capacitor 510 illustrated in FIG. 12 produces advantageous effects the same as or similar to those of the multilayer ceramic capacitor 10.

### 2. Method for Producing Multilayer Ceramic Capacitor

Next, an example of a method for producing the multilayer ceramic capacitor 510 according to the third example embodiment is described.

First, a ceramic green sheet and conductive paste for internal electrode are prepared. The ceramic green sheet and the conductive paste for internal electrode include a binder (e.g., a publicly-known organic binder) and a solvent (e.g., an organic solvent).

Next, the conductive paste for internal electrode is applied in a predetermined pattern on the ceramic green sheet, for example, by screen printing, gravure printing, or the like, and thus an internal electrode pattern such as the one illustrated in FIG. 23 is formed. Specifically, a conductive paste layer is formed by applying paste made of a conductive material onto the ceramic green sheet by a method such as the above printing method, for example. The paste made of a conductive material is, for example, produced by adding an organic binder and an organic solvent to metal power. As for the ceramic green sheet, a ceramic green sheet for outer layer on which no internal electrode pattern is printed is also produced.

A multilayer sheet is produced by using such ceramic green sheets on which the internal electrode pattern is formed. Specifically, the multilayer sheet is produced by laminating a predetermined number of ceramic green sheets for outer layer on which no internal electrode pattern is formed, alternately laminating thereon a ceramic green sheet on which an internal electrode pattern corresponding to the first internal electrode layer 516a is formed and a ceramic green sheet on which an internal electrode pattern corresponding to the second internal electrode layer 516b is formed, and laminating thereon a predetermined number of ceramic green sheets for outer layer on which no internal electrode pattern is formed.

Subsequently, a multilayer body block is produced by pressure-bonding the multilayer body sheet in a laminating direction by, for example, an isostatic press.

Subsequently, the multilayer block is cut into a predetermined size, and a multilayer chip is thus produced. In this process, corner portions and ridge portions of the multilayer chip may be rounded by barrel polishing, for example.

Next, the multilayer chip is baked to produce the multilayer body 512 such as the one illustrated in FIG. 23. A baking temperature is, for example, preferably equal to or greater than about 900° C. and equal to or less than about 1400° C. although the baking temperature depends on materials used for the ceramics and internal electrode layers.

In this state, as illustrated in FIG. 23, the first extended electrode portions 520a of the first internal electrode layers 516a are exposed from the first side surface 512c and the third side surface 512e of the multilayer body 512, and the third extended electrode portions 521a of the second internal electrode layers 516b are exposed from the first side surface 512c and the fourth side surface 512f of the multilayer body 512. Furthermore, the second extended electrode portions 520b of the first internal electrode layers 516a are exposed from the second side surface 512d and the fourth side surface 512f of the multilayer body 512, and the fourth extended electrode portions 521b of the second internal electrode layers 516b are exposed from the second side surface 512d and the third side surface 512e of the multilayer body 512.

Subsequently, the thin film layers 526 and 527 are formed on a portion of the first main surface 512a, a portion of the second main surface 512b, a portion of the first side surface 512c, a portion of the second side surface 512d, a portion of the third side surface 512e, and a portion of the fourth side surface 512f of the multilayer body 512

For example, a resist made of a resin or the like is disposed on the first main surface 512a, the second main surface 512b, the first side surface 512c, the second side surface 512d, the third side surface 512e, and the fourth side surface 512f of the multilayer body 512, and the first thin film layer 526a, the second thin film layer 526b, the third thin film layer 527a, and the fourth thin film layer 527b are disposed on the resist and the first main surface 512a, the second main surface 512b, the first side surface 512c, the second side surface 512d, the third side surface 512e, and the fourth side surface 512f of the multilayer body 512 by, for example, a sputtering method, a screen printing method, or the like. Then, a resist portion is peeled. In this way, the end edge portions of the first thin film layer 526a, the second thin film layer 526b, the third thin film layer 527a, and the fourth thin film layer 527b that are located adjacent to the center of the multilayer body 512 in the length direction z and/or the width direction y can be spaced apart from the multilayer body 512.

Then, for example, a Cu plating layer that is the first lower plating layer 528a is formed so as to cover the first thin film layer 526a. At the end edge portion of the first thin film layer 526a that is located adjacent to the center of the multilayer body 512 in the length direction z and/or the width direction y, the first lower plating layer 528a is formed so as to be in between the multilayer body 512 and the first thin film layer 526a.

A Cu plating layer that is the second lower plating layer 528b is formed so as to cover the second thin film layer 526b. At the end edge portion of the second thin film layer 526b that is located adjacent to the center of the multilayer body 512 in the length direction z and/or the width direction y and/or the laminating direction x, the second lower plating layer 528b is formed so as to be in between the multilayer body 512 and the second thin film layer 526b.

A Cu plating layer that is the third lower plating layer 529a is formed so as to cover the third thin film layer 527a. At the end edge portion of the third thin film layer 527a that is located adjacent to the center of the multilayer body 512 in the length direction z and/or the width direction y and/or the laminating direction x, the third lower plating layer 529a is formed so as to be in between the multilayer body 512 and the third thin film layer 527a.

A Cu plating layer that is the fourth lower plating layer 529b is formed so as to cover the fourth thin film layer 527b. At the end edge portion of the fourth thin film layer 527b that is located adjacent to the center of the multilayer body 512 in the length direction z and/or the width direction y and/or the laminating direction x, the fourth lower plating layer 529b is formed so as to be in between the multilayer body 512 and the fourth thin film layer 527b.

Subsequently, for example, Ni plating layers that are the upper plating layers 530 and 531 are formed on surfaces of the lower plating layers 528 and 529. Then, for example, Sn plating layers that are front plating layers 532 and 533 are formed on surfaces of the upper plating layers 530 and 531. At the time of formation of the lower plating layers 528 and 529, the upper plating layers 530 and 531, and the front plating layers 532 and 533, for example, electrolytic plating using an electrolytic plating bath mixed with an additive or electroless plating using substitution reaction is performed.

By disposing a resist on the first main surface 512a after formation of the thin film layers 526 and 527 and performing electrolytic plating or electroless plating, the end edge portions of the lower plating layers 528 and 529 that are located close the center of the multilayer body 512 in the length direction z can be spaced apart from the multilayer body 512 in the laminating direction x and/or the width direction y and/or the length direction z. The resist may be disposed after formation and baking of the thin film layers 526 and 527.

In this way, the multilayer ceramic capacitor 510 illustrated in FIG. 12 is produced.

### D. Fourth Example Embodiment

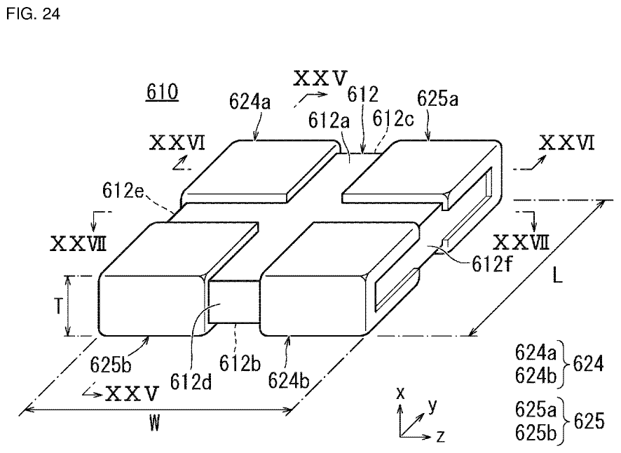

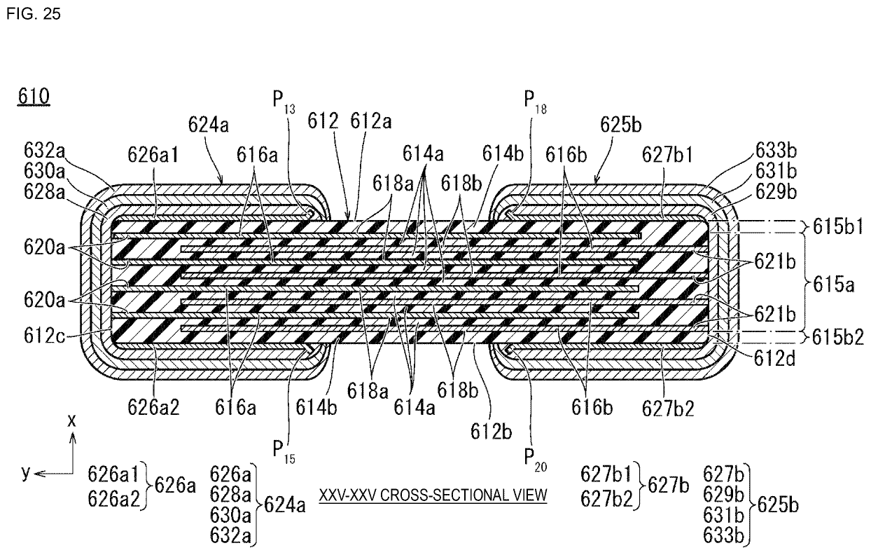

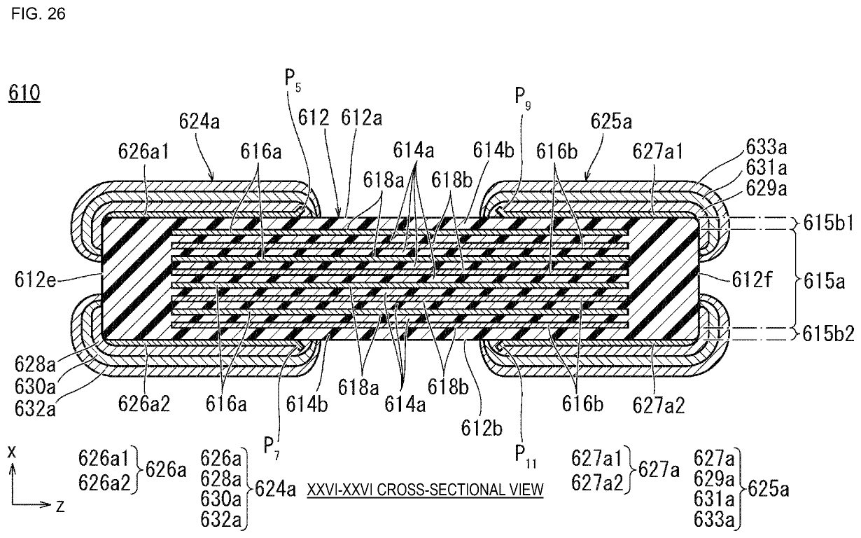

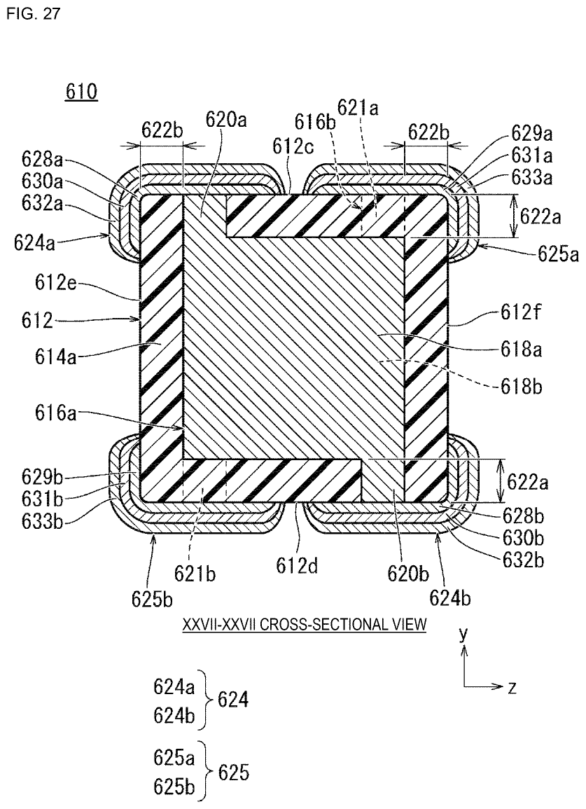

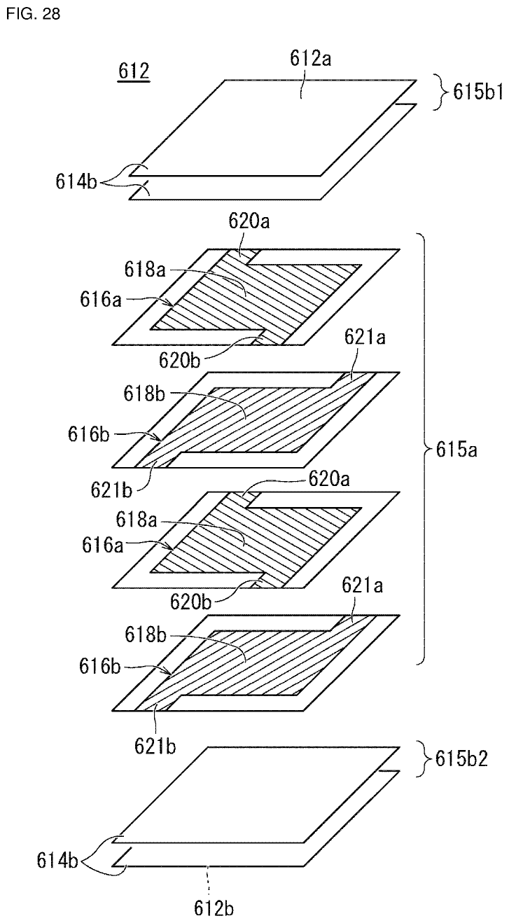

Next, a multilayer ceramic capacitor 610 according to a fourth example embodiment of the present invention is described. FIG. 24 is an external perspective view illustrating a multilayer ceramic capacitor according to the fourth example embodiment of the present invention. FIG. 25 is a cross-sectional view taken along line XXV-XXV in FIG. 24. FIG. 26 is a cross-sectional view taken along line XXVI-XXVI in FIG. 24. FIG. 27 is a cross-sectional view taken along line XXVII-XXVII in FIG. 24. FIG. 28 is an exploded perspective view of a multilayer body illustrated in FIG. 24.

The multilayer ceramic capacitor 610 according to the fourth example embodiment is different from the multilayer ceramic capacitor 510 according to the third example embodiment in the shapes of internal electrode layers 516 and the shapes of outer electrodes 524 and 525. Accordingly, elements corresponding to those in the third example embodiment are denoted by the reference signs, and detailed description thereof is omitted.

The multilayer ceramic capacitor 610 includes a multilayer body 612 and outer electrodes 624 and 625.

The multilayer body 612 includes a plurality of dielectric layers 614 and a plurality of internal electrode layers 616. The multilayer body 612 includes a first main surface 612a and a second main surface 612b that are opposed to each other in a laminating direction x, a first side surface 612c and a second side surface 612d that are opposed to each other in a width direction y orthogonal or substantially orthogonal to the laminating direction x, and a third side surface 612e and a fourth side surface 612f that are opposed to each other in a length direction N orthogonal or substantially orthogonal to the laminating direction x and the width direction y. The first main surface 612a and the second main surface 612b extend in the width direction y and the length direction z. The first side surface 612c and the second side surface 612d extend along the laminating direction x and the length direction z. The third side surface 612e and the fourth side surface 612f extend along the laminating direction x and the width direction y. Accordingly, the laminating direction x is a direction connecting the first main surface 612a and the second main surface 612b, the width direction y is a direction connecting the first side surface 612c and the second side surface 612d, and the length direction z is a direction connecting the third side surface 612e and the fourth side surface 612f.

As illustrated in FIGS. 25 and 26, the multilayer body 612 includes an inner layer portion 615a in which the plurality of internal electrode layers 616 face each other in the laminating direction x connecting the first main surface 612a and the second main surface 612b, a first main-surface-side outer layer portion 615b1 including a plurality of dielectric layers 614 located between an internal electrode layer 616 closest to the first main surface 612a and the first main surface 612a, and a second main-surface-side outer layer portion 615b2 including a plurality of dielectric layers 614 located between an internal electrode layer 616 closest to the second main surface 612b and the second main surface 612b.

The dielectric layers 614 include an inner dielectric layer 614a, which is a dielectric layer 614 of the inner layer portion 615a, and outer dielectric layers 614b, which are dielectric layers 614 of the first main-surface-side outer layer portion 615b1 and the second main-surface-side outer layer portion 615b2.

The first main-surface-side outer layer portion 615b1 is a collection of a plurality of outer dielectric layers 614b that are located close to the first main surface 612a of the multilayer body 612 and are located between the first main surface 612a and the internal electrode layer 616 closest to the first main surface 612a.

The second main-surface-side outer layer portion 615b2 is a collection of a plurality of outer dielectric layers 614b that are located close to the second main surface 612b of the multilayer body 612 and are located between the second main surface 612b and the internal electrode layer 616 closest to the second main surface 612b.

The inner layer portion 615a is a region sandwiched between the first main-surface-side outer layer portion 615b1 and the second main-surface-side outer layer portion 615b2. That is, the inner layer portion 615a is a region where the internal electrode layers 616 are laminated.

A material for the dielectric layers 614 is the same as that for the dielectric layers 514 of the multilayer ceramic capacitor 510 according to the third example embodiment, and therefore description thereof is omitted.

As illustrated in FIGS. 25 to 27, the internal electrode layers 616 include a plurality of first internal electrode layers 616a and a plurality of second internal electrode layers 616b. The first internal electrode layers 616a and the second internal electrode layers 616b are alternately laminated in a direction connecting the first main surface 612a and the second main surface 612b with the inner dielectric layer 614a interposed therebetween.

Each of the first internal electrode layers 616a is disposed on a surface of the inner dielectric layer 614a. The first internal electrode layers 616a include a first opposed electrode portion 618a that faces the first main surface 612a and the second main surface 612b and faces the second internal electrode layers 616b, and are laminated in the direction connecting the first main surface 612a and the second main surface 612b.

Each of the second internal electrode layers 616b is disposed on a surface of the inner dielectric layer 614a different from the inner dielectric layer 614a on which the first internal electrode layer 616a is disposed. The second internal electrode layers 616b include a second opposed electrode portion 618b that faces the first main surface 612a and the second main surface 612b and are laminated in the direction connecting the first main surface 612a and the second main surface 612b.

As illustrated in FIG. 27, each of the first internal electrode layers 616a is extended to the first side surface 612c of the multilayer body 612 by a first extended electrode portion 620a and is extended to the second side surface 612d of the multilayer body 612 by a second extended electrode portion 620b.

As illustrated in FIG. 27, each of the second internal electrode layers 616b is extended to the first side surface 612c of the multilayer body 612 by a third extended electrode portion 621a and is extended to the second side surface 612d of the multilayer body 612 by a fourth extended electrode portion 621b.

As illustrated in FIG. 27, the multilayer body 612 includes an end portion (L gap) 622b of the multilayer body 612 that is provided between one end of the first opposed electrode portion 618a in the length direction z and the third side surface 612e and between the other end of the second opposed electrode portion 618b in the length direction z and the fourth side surface 612f.

Furthermore, as illustrated in FIG. 27, the multilayer body 612 includes a side portion (W gap) 622a of the multilayer body 612 that is provided between one end of the first opposed electrode portion 618a in the width direction y and the first side surface 612c and between the other end of the second opposed electrode portion 618b in the width direction y and the second side surface 612d.

A shape of the first opposed electrode portions 618a of the first internal electrode layers 616a is not limited in particular and is, for example, preferably rectangular or substantially rectangular in plan view. Corner portions of the first opposed electrode portions 618a in plan view may be rounded or the corner portions may be inclined (tapered) in plan view. Alternatively, the first opposed electrode portions 618a may have a tapered shape inclined toward one side in plan view.

A shape of the first extended electrode portions 620a and the second extended electrode portions 620b of the first internal electrode layers 616a is not limited in particular and is, for example, preferably rectangular or substantially rectangular in plan view. Corner portions of the first extended electrode portions 620a and the second extended electrode portions 620b in plan view may be rounded or the corner portions may be inclined (tapered) in plan view. Alternatively, the first extended electrode portions 620a and the second extended electrode portions 620b may have a tapered shape inclined toward one side in plan view.

A shape of the second opposed electrode portions 618b of the second internal electrode layers 616b is not limited in particular and is, for example, preferably rectangular or substantially rectangular in plan view. Corner portions of the second opposed electrode portions 618b in plan view may be rounded or the corner portions may be inclined (tapered) in plan view. Alternatively, the second opposed electrode portions 618b may have a tapered shape inclined toward one side in plan view.

A shape of the third extended electrode portions 621a and the fourth extended electrode portions 621b of the second internal electrode layers 616b is not limited in particular and is, for example, preferably rectangular or substantially rectangular in plan view. Corner portions of the third extended electrode portions 621a and the fourth extended electrode portions 621b in plan view may be rounded or the corner portions may be inclined (tapered) in plan view. Alternatively, the third extended electrode portions 621a and the fourth extended electrode portions 621b may have a tapered shape inclined toward one side in plan view.

A material for the internal electrode layers 616 is the same as that for the internal electrode layers 516 of the multilayer ceramic capacitor 510 according to the third example embodiment, and therefore description thereof is omitted.

The outer electrodes 624 and 625 are disposed on the multilayer body 612.

The outer electrode 624 includes a first outer electrode 624a and a second outer electrode 624b.

The first outer electrode 624a covers the first extended electrode portions 620a on the first side surface 612c and covers the first main surface 612a, the second main surface 612b, and a portion of the third side surface 612e. The first outer electrode 624a is electrically connected to the first extended electrode portions 620a of the first internal electrode layers 616a.

The second outer electrode 624b covers the second extended electrode portions 620b on the second side surface 612d and covers the first main surface 612a, the second main surface 612b, and a portion of the fourth side surface 612f. The second outer electrode 624b is electrically connected to the second extended electrode portions 620b of the first internal electrode layers 616a.

The outer electrode 625 includes a third outer electrode 625a and a fourth outer electrode 625b.

The third outer electrode 625a covers the third extended electrode portions 621a on the first side surface 612c and covers the first main surface 612a, the second main surface 612b, and a portion of the fourth side surface 612f. The third outer electrode 625a is electrically connected to the third extended electrode portions 621a of the second internal electrode layers 616b.

The fourth outer electrode 625b covers the fourth extended electrode portions 621b on the second side surface 612d and covers the first main surface 612a, the second main surface 612b, and a portion of the third side surface 612e. The fourth outer electrode 625b is electrically connected to the fourth extended electrode portions 621b of the second internal electrode layers 616b.

In the multilayer body 612, the first opposed electrode portions 618a of the first internal electrode layers 616a and the second opposed electrode portions 618b of the second internal electrode layers 616b face each other with the inner dielectric layer 614a interposed therebetween. This generates an electrostatic capacitance. Accordingly, an electrostatic capacitance can be obtained between the first outer electrode 624a and the second outer electrode 624b to which the first internal electrode layers 616a are connected and the third outer electrode 625a and the fourth outer electrode 625b to which the second internal electrode layers 616b are connected, and thus characteristics of the capacitor are provided.

In the present example embodiment, the outer electrodes 624 and 625 are disposed on the first main surface 612a and the second main surface 612b of the multilayer body 612. However, the outer electrodes 624 and 625 need not be disposed on the second main surface 612b, as long as the outer electrodes 624 and 625 are disposed on the first main surface 612a of the multilayer body 612.

A thin film layer 626 includes a first thin film layer 626a and a second thin film layer 626b.

The first thin film layer 626a includes a first main-surface-side thin film layer 626a1 that covers a portion of the first main surface 612a at a corner portion where the first main surface 612a, the first side surface 612c, and the third side surface 612e of the multilayer body 612 cross and a third main-surface-side thin film layer 626a2 that covers a portion of the second main surface 612b at a corner portion where the second main surface 612b, the first side surface 612c, and the third side surface 612e of the multilayer body 612 cross.

The second thin film layer 626b includes a second main-surface-side thin film layer 626b1 that covers a portion of the first main surface 612a at a corner portion where the first main surface 612a, the second side surface 612d, and the fourth side surface 612f of the multilayer body 612 cross and a fourth main-surface-side thin film layer 626b2 that covers a portion of the second main surface 612b at a corner portion where the second main surface 612b, the second side surface 612d, and the fourth side surface 612f of the multilayer body 612 cross.

A thin film layer 627 includes a third thin film layer 627a and a fourth thin film layer 627b.

The third thin film layer 627a includes a fifth main-surface side thin film layer 627a1 that covers a portion of the first main surface 612a at a corner portion where the first main surface 612a, the first side surface 612c, and the fourth side surface 612f of the multilayer body 612 cross and a seventh main-surface side thin film layer 627a2 that covers a portion of the second main surface 612b at a corner portion where the second main surface 612b, the first side surface 612c, and the fourth side surface 612f of the multilayer body 612 cross.

The fourth thin film layer 627b includes a sixth main-surface-side thin film layer 627b1 that covers a portion of the first main surface 612a at a corner portion where the first main surface 612a, the second side surface 612d, and the third side surface 612e of the multilayer body 612 cross and an eighth main-surface-side thin film layer 627b2 that covers a portion of the second main surface 612b at a corner portion where the second main surface 612b, the second side surface 612d, and the third side surface 612e of the multilayer body 612 cross.

An end edge portion P₅ of the first main-surface-side thin film layer 626a1 that is located adjacent to a center of the multilayer body 612 in the length direction z is spaced apart from the multilayer body 612 in the laminating direction x. That is, the end edge portion P₅ of the first main-surface-side thin film layer 626a1 that is located adjacent to the center of the multilayer body 612 in the length direction z is floating above the multilayer body 612. Since the end edge portion P₅ of the first main-surface-side thin film layer 626a1 is continuously floating in the width direction y, tensile stress applied to the end edge portion P₅ of the first main-surface-side thin film layer 626a1 can be maintained small even upon application of thermal stress. This can reduce or prevent the occurrence of a crack in the multilayer body 612 caused by thermal stress.

Among positions of the end edge portion P₅ of the first main-surface-side thin film layer 626a1 that is located adjacent to the center of the multilayer body 612 in the length direction z, a position of the first main-surface-side thin film layer 626a1 that is closest in the length direction z to the center of the multilayer body 612 in the length direction z is referred to as a position A₁, a position at which the first main-surface-side thin film layer 626a1 starts to be spaced apart from the multilayer body 612 in the laminating direction x is referred to as a position B₁, and a position at which a perpendicular or substantially perpendicular line extending from the position A₁ in the laminating direction x crosses the multilayer body 612 is referred to as a position C₁. It is preferable that ∠A₁B₁C₁ is, for example, equal to or greater than about 20 degrees and equal to or less than about 70 degrees. By using the numerical range, the end edge portion P₅ of the first main-surface-side thin film layer 626a1 that is located adjacent to the center of the multilayer body 612 in the length direction z is sufficiently spaced apart from the multilayer body 612, and a distance from the position B₁ to the position C₁ in the length direction z can be made sufficient. Accordingly, a direction of compressive stress can be sufficiently changed. As a result, tensile stress applied to the end edge portion P₅ of the first main-surface-side thin film layer 626a1 can be maintained small even upon application of thermal stress. This can reduce or prevent the occurrence of a crack in the multilayer body 612 caused by thermal stress.

A distance from the position A₁ to the position B₁ in the length direction z is, for example, preferably equal to or greater than about 5 μm and equal to or less than about 20 μm. Accordingly, the distance from the position A₁ to the position B₁ can be made sufficient, and therefore the direction of the compressive stress can be sufficiently changed. On the other hand, in a case where the distance from the position A₁ to the position B₁ in the length direction z is less than about 5 μm, the end edge portion P₅ of the first main-surface-side thin film layer 626a1 that is located adjacent to the center of the multilayer body 612 in the length direction z cannot be sufficiently spaced apart from the multilayer body 612. In a case where the distance from the position A₁ to the position B₁ in the length direction z is larger than about 20 μm, a crack may undesirably occur in the multilayer body 612 due to excessive stress of the first main-surface-side thin film layer 626a1.

Similarly, an end edge portion P₆ of the second main-surface-side thin film layer 626bl that is located adjacent to the center of the multilayer body 612 in the length direction z is spaced apart from the multilayer body 612 in the laminating direction x. That is, the end edge portion P₆ of the second main-surface-side thin film layer 626b1 that is located adjacent to the center of the multilayer body 612 in the length direction z is floating above the multilayer body 612.

An end edge portion P₇ of the third main-surface-side thin film layer 626a2 that is located adjacent to the center of the multilayer body 612 in the length direction z is spaced apart from the multilayer body 612 in the laminating direction x. That is, the end edge portion P₇ of the third main-surface-side thin film layer 626a2 that is located adjacent to the center of the multilayer body 612 in the length direction z is floating above the multilayer body 612.

An end edge portion P₈ of the fourth main-surface-side thin film layer 626b2 that is located adjacent to the center of the multilayer body 612 in the length direction z is spaced apart from the multilayer body 612 in the laminating direction x. That is, the end edge portion Pe of the fourth main-surface-side thin film layer 626b2 that is located adjacent to the center of the multilayer body 612 in the length direction z is floating above the multilayer body 612.

An end edge portion P₉ of the fifth main-surface side thin film layer 627a1 that is located adjacent to the center of the multilayer body 612 in the length direction z is spaced apart from the multilayer body 612 in the laminating direction x. That is, the end edge portion P₉ of the fifth main-surface side thin film layer 627a1 that is located adjacent to the center of the multilayer body 612 in the length direction z is floating above the multilayer body 612.

An end edge portion P₁₀ of the sixth main-surface-side thin film layer 627b1 that is located adjacent to the center of the multilayer body 612 in the length direction z is spaced apart from the multilayer body 612 in the laminating direction x. That is, the end edge portion P₁₀ of the sixth main-surface-side thin film layer 627b1 that is located adjacent to the center of the multilayer body 612 in the length direction z is floating above the multilayer body 612.

An end edge portion P₁₁ of the seventh main-surface side thin film layer 627a2 that is located adjacent to the center of the multilayer body 612 in the length direction z is spaced apart from the multilayer body 612 in the laminating direction x. That is, the end edge portion Pu of the seventh main-surface side thin film layer 627a2 that is located adjacent to the center of the multilayer body 612 in the length direction z is floating above the multilayer body 612.

An end edge portion P₁₂ of the eighth main-surface-side thin film layer 627b2 that is located adjacent to the center of the multilayer body 612 in the length direction z is spaced apart from the multilayer body 612 in the laminating direction x. That is, the end edge portion P₁₂ of the eighth main-surface-side thin film layer 627b2 that is located adjacent to the center of the multilayer body 612 in the length direction z is floating above the multilayer body 612.

As for the second main-surface-side thin film layer 626b1, the third main-surface-side thin film layer 626a2, the fourth main-surface-side thin film layer 626b2, the fifth main-surface side thin film layer 627al, the sixth main-surface-side thin film layer 627b1, the seventh main-surface side thin film layer 627a2, and the eighth main-surface-side thin film layer 627b2, the end edge portions P₆, P₇, P₈, P₉, P₁₀, P₁₁, and P₁₂ are continuously floating in the width direction y, and therefore tensile stress applied to the end edge portions P₆, P₇, P₈, P₉, P₁₀, P₁₁, and P₁₂ can be maintained small even upon application of thermal stress, as with the first main-surface-side thin film layer 626a1. This can reduce or prevent the occurrence of a crack in the multilayer body 612 caused by thermal stress.

An end edge portion P₁₃ of the first main-surface-side thin film layer 626a1 that is located adjacent to a center of the multilayer body 612 in the width direction y is spaced apart from the multilayer body 612 in the laminating direction x. That is, the end edge portion P₁₃ of the first main-surface-side thin film layer 626a1 that is located adjacent to the center of the multilayer body 612 in the width direction y is floating above the multilayer body 612. Since the end edge portion P₁₃ of the first main-surface-side thin film layer 626a1 is continuously floating in the length direction z, tensile stress applied to the end edge portion P₁₃ of the first main-surface-side thin film layer 626a1 can be maintained small even upon application of thermal stress. This can reduce or prevent the occurrence of a crack in the multilayer body 612 caused by thermal stress.

Among positions of the end edge portion P₁₃ of the first main-surface-side thin film layer 626a1 that is located adjacent to the center of the multilayer body 612 in the width direction y, a position of the first main-surface-side thin film layer 626a1 that is closest in the width direction y to the center of the multilayer body 612 in the width direction y is referred to as a position A₂, a position at which the first main-surface-side thin film layer 626a1 starts to be spaced apart from the multilayer body 612 in the laminating direction x is referred to as a position Be, and a position at which a perpendicular or substantially perpendicular line extending from the position A₂ in the laminating direction x crosses the multilayer body 612 is referred to as a position C₂. It is preferable that ∠A₂B₂C₂ is, for example, equal to or greater than about 20 degrees and equal to or less than about 70 degrees. By using the numerical range, the end edge portion P₁₃ of the first main-surface-side thin film layer 626a1 that is located adjacent to the center of the multilayer body 612 in the width direction y is sufficiently spaced apart from the multilayer body 612, and a distance from the position Be to the position C₂ in the width direction y can be made sufficient. Accordingly, a direction of compressive stress can be sufficiently changed. As a result, tensile stress applied to the end edge portion P₁₃ of the first main-surface-side thin film layer 626a1 can be made small even upon application of thermal stress. This can reduce or prevent the occurrence of a crack in the multilayer body 612 caused by thermal stress.

A distance from the position A₂ to the position Be in the width direction y is, for example, preferably equal to or greater than about 5 μm and equal to or less than about 20 μm. Accordingly, the distance from the position A₂ to the position B₂ can be made sufficient, and therefore the direction of the compressive stress can be sufficiently changed. On the other hand, in a case where the distance from the position A₂ to the position B₂ in the width direction y is less than about 5 μm, the end edge portion P₁₃ of the first main-surface-side thin film layer 626a1 that is located adjacent to the center of the multilayer body 612 in the width direction y cannot be sufficiently spaced apart from the multilayer body 612. In a case where the distance from the position A₂ to the position B₂ in the width direction y is larger than about 20 μm, a crack may undesirably occur in the multilayer body 612 due to excessive stress of the first main-surface-side thin film layer 626a1.

Similarly, an end edge portion P₁₄ of the second main-surface-side thin film layer 626b1 that is located adjacent to the center of the multilayer body 612 in the width direction y is spaced apart from the multilayer body 612 in the laminating direction x. That is, the end edge portion P₁₄ of the second main-surface-side thin film layer 626b1 that is located adjacent to the center of the multilayer body 612 in the width direction y is floating above the multilayer body 612.

An end edge portion P₁₅ of the third main-surface-side thin film layer 626a2 that is located adjacent to the center of the multilayer body 612 in the width direction y is spaced apart from the multilayer body 612 in the laminating direction x. That is, the end edge portion P₁₅ of the third main-surface-side thin film layer 626a2 that is located adjacent to the center of the multilayer body 612 in the width direction y is floating above the multilayer body 612.

An end edge portion P₁₆ of the fourth main-surface-side thin film layer 626b2 that is located adjacent to the center of the multilayer body 612 in the width direction y is spaced apart from the multilayer body 612 in the laminating direction x. That is, the end edge portion P₁₆ of the fourth main-surface-side thin film layer 626b2 that is located adjacent to the center of the multilayer body 612 in the width direction y is floating above the multilayer body 612.

An end edge portion P₁₇ of the fifth main-surface side thin film layer 627a1 that is located adjacent to the center of the multilayer body 612 in the width direction y is spaced apart from the multilayer body 612 in the laminating direction x. That is, the end edge portion Piz of the fifth main-surface side thin film layer 627a1 that is located adjacent to the center of the multilayer body 612 in the width direction y is floating above the multilayer body 612.

An end edge portion P₁₈ of the sixth main-surface-side thin film layer 627b1 that is located adjacent to the center of the multilayer body 612 in the width direction y is spaced apart from the multilayer body 612 in the laminating direction x. That is, the end edge portion P₁₈ of the sixth main-surface-side thin film layer 627b1 that is located adjacent to the center of the multilayer body 612 in the width direction y is floating above the multilayer body 612.

An end edge portion P₁₉ of the seventh main-surface side thin film layer 627a2 that is located adjacent to the center of the multilayer body 612 in the width direction y is spaced apart from the multilayer body 612 in the laminating direction x. That is, the end edge portion P₁₉ of the seventh main-surface side thin film layer 627a2 that is located adjacent to the center of the multilayer body 612 in the width direction y is floating above the multilayer body 612.

An end edge portion P₂₀ of the eighth main-surface-side thin film layer 627b2 that is located adjacent to the center of the multilayer body 612 in the width direction y is spaced apart from the multilayer body 612 in the laminating direction x. That is, the end edge portion P₂₀ of the eighth main-surface-side thin film layer 627b2 that is located adjacent to the center of the multilayer body 612 in the width direction y is floating above the multilayer body 612.

As for the second main-surface-side thin film layer 626b1, the third main-surface-side thin film layer 626a2, the fourth main-surface-side thin film layer 626b2, the fifth main-surface side thin film layer 627a1, the sixth main-surface-side thin film layer 627b1, the seventh main-surface side thin film layer 627a2, and the eighth main-surface-side thin film layer 627b2, the end edge portions P₁₄, P₁₅, P₁₆, P₁₇, P₁₈, P₁₉, and P₂₀ are continuously floating in the length direction z, and therefore tensile stress applied to the end edge portions P₁₄, P₁₅, P₁₆, P₁₇, P₁₈, P₁₉, and P₂₀ can be maintained small even upon application of thermal stress, as with the first main-surface-side thin film layer 626a1. This can reduce or prevent the occurrence of a crack in the multilayer body 612 caused by thermal stress.

A lower plating layer 628 includes a first lower plating layer 628a and a second lower plating layer 628b. A lower plating layer 629 includes a third lower plating layer 629a and a fourth lower plating layer 629b. The lower plating layers 628 and 629 are disposed on the thin film layers 626 and 627 and on the first side surface 612c and the second side surface 612d, and the third side surface 612e and the fourth side surface 612f. The lower plating layers 628 and 629 are provided so as to be in between the multilayer body 612 and the thin film layers 626 and 627.

The first lower plating layer 628a is disposed on the first side surface 612c of the multilayer body 612 on which the thin film layer 626 is not disposed, and covers the first main-surface-side thin film layer 626a1 disposed on the first main surface 612a and the third main-surface-side thin film layer 626a2 disposed on the second main surface 612b.

The second lower plating layer 628b is disposed on the second side surface 612d of the multilayer body 612 on which the thin film layer 626 is not disposed, and covers the second main-surface-side thin film layer 626b1 disposed on the first main surface 612a and the fourth main-surface-side thin film layer 626b2 disposed on the second main surface 612b.

The third lower plating layer 629a is disposed on the first side surface 612c of the multilayer body 612 on which the thin film layer 627 is not disposed, and covers the fifth main-surface side thin film layer 627a1 disposed on the first main surface 612a and the seventh main-surface side thin film layer 627a2 disposed on the second main surface 612b.

The fourth lower plating layer 629b is disposed on the second side surface 612d of the multilayer body 612 on which the thin film layer 627 is not disposed, and covers the sixth main-surface-side thin film layer 627b1 disposed on the first main surface 612a and the eighth main-surface-side thin film layer 627b2 disposed on the second main surface 612b.

An upper plating layer 630 includes a first upper plating layer 630a and a second upper plating layer 630b. An upper plating layer 631 includes a third upper plating layer 631a and a fourth upper plating layer 631b. The first upper plating layer 630a covers the first lower plating layer 628a. The second upper plating layer 630b covers the second lower plating layer 628b. The third upper plating layer 631a covers the third lower plating layer 629a. The fourth upper plating layer 631b covers the fourth lower plating layer 629b.

A front plating layer 632 includes a first front plating layer 632a and a second front plating layer 632b. A front plating layer 633 includes a third front plating layer 633a and a fourth front plating layer 633b. The first front plating layer 632a covers the first upper plating layer 630a. The second front plating layer 632b covers the second upper plating layer 630b. The third front plating layer 633a covers the third upper plating layer 631a. The fourth front plating layer 633b covers the fourth upper plating layer 631b.

As illustrated in FIG. 24, in the present example embodiment, the outer electrodes 624 and 625 have a U shape with right-angled corners when viewed from the third side surface 612e or the fourth side surface 612f of the multilayer body 612. However, this is not restrictive, and the outer electrodes 624 and 625 can have, for example, a V shape or a U shape with round corners when viewed from the third side surface 612e or the fourth side surface 612f of the multilayer body 612.

### E. Fifth Example Embodiment

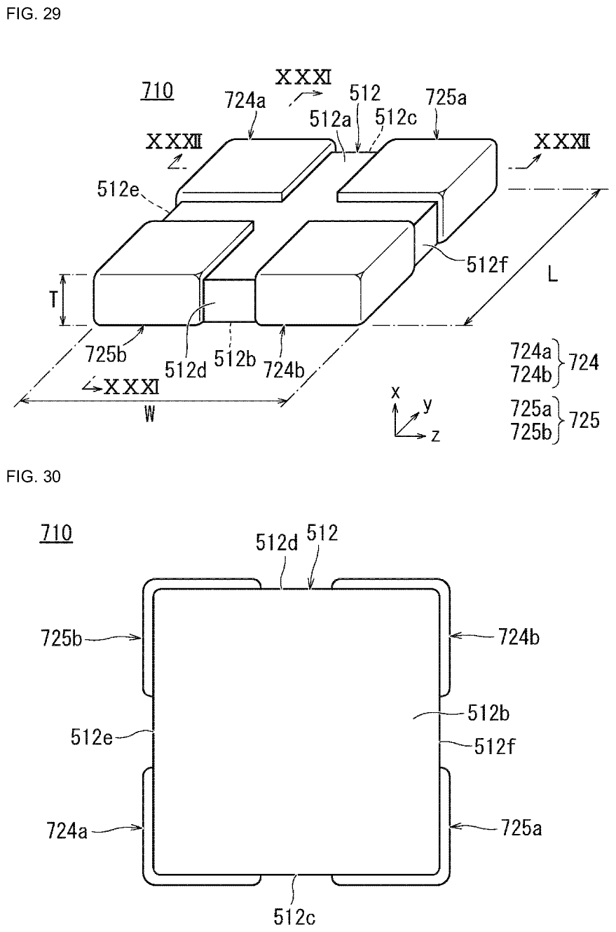

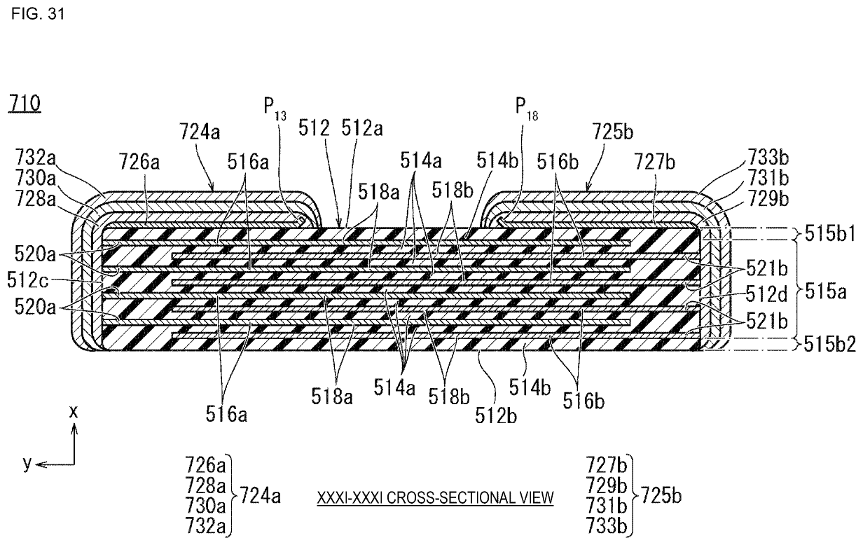

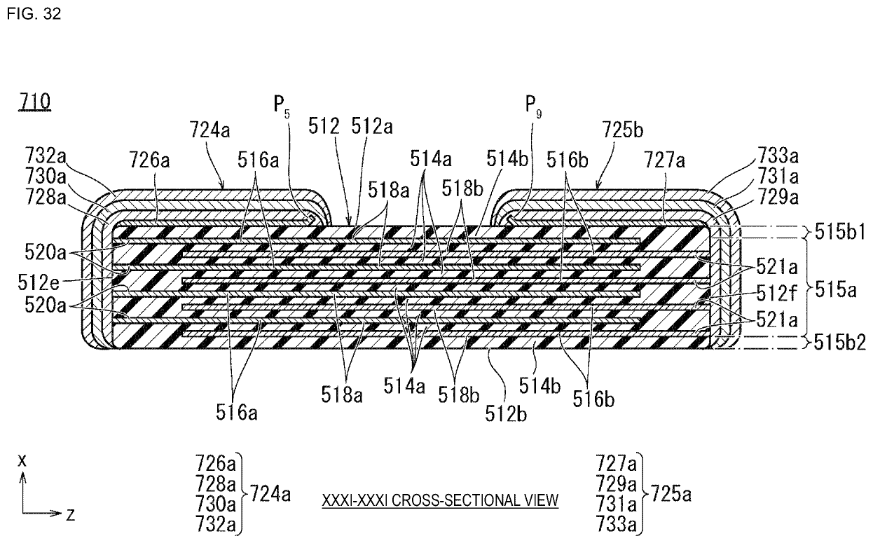

Next, a multilayer ceramic capacitor 710 according to a fifth example embodiment of the present invention is described. FIG. 29 is an external perspective view illustrating a multilayer ceramic capacitor according to the fifth example embodiment of the present invention. FIG. 30 is a bottom view illustrating the multilayer ceramic capacitor according to the fifth example embodiment of the present invention. FIG. 31 is a cross-sectional view taken along line XXXI-XXXI in FIG. 29. FIG. 32 is a cross-sectional view taken along line XXXII-XXXII in FIG. 29.

The multilayer ceramic capacitor 710 according to the fifth example embodiment is different from the multilayer ceramic capacitor 510 according to the third example embodiment in the shape of outer electrodes. Therefore, elements corresponding to those of the third example embodiment are denoted by the same reference signs, and detailed description thereof is omitted.

The multilayer ceramic capacitor 710 includes a multilayer body 512 and outer electrodes 724 and 725.

The outer electrode 724 includes a first outer electrode 724a and a second outer electrode 724b.

The first outer electrode 724a covers a first extended electrode portion 520a on a first side surface 512c and a third side surface 512e and covers a portion of a first main surface 512a. The first outer electrode 724a is electrically connected to the first extended electrode portion 520a of a first internal electrode layer 516a.

The second outer electrode 724b covers a second extended electrode portion 520b on a second side surface 512d and a fourth side surface 512f, and covers a portion of the first main surface 512a. The second outer electrode 724b is electrically connected to the second extended electrode portion 520b of the first internal electrode layer 516a.

The outer electrode 725 includes a third outer electrode 725a and a fourth outer electrode 725b.

The third outer electrode 725a covers a third extended electrode portion 521a on the first side surface 512c and the fourth side surface 512f, and covers a portion of the first main surface 512a. The third outer electrode 725a is electrically connected to the third extended electrode portion 521a of a second internal electrode layer 516b.

The fourth outer electrode 725b covers a fourth extended electrode portion 521b on the second side surface 512d and the third side surface 512e and covers a portion of the first main surface 512a. The fourth outer electrode 725b is electrically connected to the fourth extended electrode portion 521b of the second internal electrode layer 516b.

In the multilayer body 512, a first opposed electrode portion 518a of the first internal electrode layer 516a and a second opposed electrode portion 518b of the second internal electrode layer 516b face each other with an inner dielectric layer 514a interposed therebetween. This generates an electrostatic capacitance. Accordingly, an electrostatic capacitance can be obtained between the first outer electrode 724a and the second outer electrode 724b to which the first internal electrode layer 516a is connected and the third outer electrode 725a and the fourth outer electrode 725b to which the second internal electrode layers 516b is connected, and thus characteristics of the capacitor are provided.

A thin film layer 726 includes a first thin film layer 726a and a second thin film layer 726b.

The first thin film layer 726a covers a portion of the first main surface 512a at a corner portion where the first main surface 512a, the first side surface 512c, and the third side surface 512e of the multilayer body 512 cross.

The second thin film layer 726b covers a portion of the first main surface 512a at a corner portion where the first main surface 512a, the second side surface 512d, and the fourth side surface 512f of the multilayer body 512 cross.

A thin film layer 727 includes a third thin film layer 727a and a fourth thin film layer 727b.

The third thin film layer 727a covers a portion of the first main surface 512a at a corner portion where the first main surface 512a, the first side surface 512c, and the fourth side surface 512f of the multilayer body 512 cross.

The fourth thin film layer 727b covers a portion of the first main surface 512a at a corner portion where the first main surface 512a, the second side surface 512d, and the third side surface 512e of the multilayer body 512 cross.

An end edge portion P₅ of the first thin film layer 726a that is located adjacent to a center of the multilayer body 512 in a length direction z is spaced apart from the multilayer body 512 in a laminating direction x. That is, the end edge portion P₅ of the first thin film layer 726a that is located adjacent to the center of the multilayer body 512 in the length direction z is floating above the multilayer body 512. Since the end edge portion P₅ of the first thin film layer 726a is continuously floating in a width direction y, tensile stress applied to the end edge portion P₅ of the first thin film layer 726a can be maintained small even upon application of thermal stress. This can reduce or prevent the occurrence of a crack in the multilayer body 512 caused by thermal stress.

Among positions of the end edge portion P₅ of the first thin film layer 726a that is located adjacent to the center of the multilayer body 512 in the length direction z, a position of the first thin film layer 726a that is closest in the length direction z to the center of the multilayer body 512 in the length direction z is referred to as a position A₁, a position at which the first thin film layer 726a starts to be spaced apart from the multilayer body 512 in the laminating direction x is referred to as a position B₁, and a position at which a perpendicular or substantially perpendicular line extending from the position A₁ in the laminating direction x crosses the multilayer body 512 is referred to as a position C₁. It is preferable that ∠A₁B₂C₁ is, for example, equal to or greater than about 20 degrees and equal to or less than about 70 degrees. By using the numerical range, the end edge portion P₅ of the first thin film layer 726a that is located adjacent to the center of the multilayer body 512 in the length direction z is sufficiently spaced apart from the multilayer body 512, and a distance from the position B₁ to the position C₁ in the length direction z can be made sufficient. Accordingly, a direction of compressive stress can be sufficiently changed. As a result, tensile stress applied to the end edge portion P₅ of the first thin film layer 726a can be maintained small even upon application of thermal stress. This can reduce or prevent the occurrence of a crack in the multilayer body 512 caused by thermal stress.

A distance from the position A₁ to the position B₁ in the length direction z is, for example, preferably equal to or greater than about 5 μm and equal to or less than about 20 μm. Accordingly, the distance from the position A₁ to the position B₁ can be made sufficient, and therefore the direction of the compressive stress can be sufficiently changed. On the other hand, in a case where the distance from the position A₁ to the position B₁ in the length direction z is less than about 5 μm, the end edge portion P₅ of the first thin film layer 726a that is located adjacent to the center of the multilayer body 512 in the length direction z cannot be sufficiently spaced apart from the multilayer body 512. In a case where the distance from the position A₁ to the position B₁ in the length direction z is larger than about 20 μm, a crack may undesirably occur in the multilayer body 512 due to excessive stress of the first thin film layer 726a.

Similarly, an end edge portion P₆ of the second thin film layer 726b that is located adjacent to the center of the multilayer body 512 in the length direction z is spaced apart from the multilayer body 512 in the laminating direction x. That is, the end edge portion P₆ of the second thin film layer 726b that is located adjacent to the center of the multilayer body 512 in the length direction z is floating above the multilayer body 512.

An end edge portion P₉ of the third thin film layer 727a that is located adjacent to the center of the multilayer body 512 in the length direction z is spaced apart from the multilayer body 512 in the laminating direction x. That is, the end edge portion P₉ of the third thin film layer 727a that is located adjacent to the center of the multilayer body 512 in the length direction z is floating above the multilayer body 512.

An end edge portion P₁₀ of the fourth thin film layer 727b that is located adjacent to the center of the multilayer body 512 in the length direction z is spaced apart from the multilayer body 512 in the laminating direction x. That is, the end edge portion P₁₀ of the fourth thin film layer 727b that is located adjacent to the center of the multilayer body 512 in the length direction z is floating above the multilayer body 512.

As for the second thin film layer 726b, the third thin film layer 727a, and the fourth thin film layer 727b, the end edge portions P₆, P₉, and P₁₀ are continuously floating in the width direction y, and therefore tensile stress applied to the end edge portions P₆, P₉, and P₁₀ can be maintained small even upon application of thermal stress, as with the first thin film layer 726a. This can reduce or prevent the occurrence of a crack in the multilayer body 512 caused by thermal stress.

An end edge portion P₁₃ of the first thin film layer 726a that is located adjacent to a center of the multilayer body 512 in the width direction y is spaced apart from the multilayer body 512 in the laminating direction x. That is, the end edge portion P₁₃ of the first thin film layer 726a that is located adjacent to the center of the multilayer body 512 in the width direction y is floating above the multilayer body 512. Since the end edge portion P₁₃ of the first thin film layer 726a is continuously floating in the length direction z, tensile stress applied to the end edge portion P₁₃ of the first thin film layer 726a can be maintained small even upon application of thermal stress. This can reduce or prevent the occurrence of a crack in the multilayer body 512 caused by thermal stress.

Among positions of the end edge portion P₁₃ of the first thin film layer 726a that is located adjacent to the center of the multilayer body 512 in the width direction y, a position of the first thin film layer 726a that is closest in the width direction y to the center of the multilayer body 512 in the width direction y is referred to as a position A₂, a position at which the first thin film layer 726a starts to be spaced apart from the multilayer body 512 in the laminating direction x is referred to as a position B₂, and a position at which a perpendicular or substantially perpendicular line extending from the position A₂ in the laminating direction x crosses the multilayer body 512 is referred to as a position C₂. It is preferable that ∠A₂B₂C₂ is, for example, equal to or greater than about 20 degrees and equal to or less than about 70 degrees. By using the numerical range, the end edge portion P₁₃ of the first thin film layer 726a that is located adjacent to the center of the multilayer body 512 in the width direction y is sufficiently spaced apart from the multilayer body 512, and a distance from the position Be to the position Ce in the width direction y can be made sufficient. Accordingly, a direction of compressive stress can be sufficiently changed. As a result, tensile stress applied to the end edge portion P₁₃ of the first thin film layer 726a can be maintained small even upon application of thermal stress. This can reduce or prevent the occurrence of a crack in the multilayer body 512 caused by thermal stress.

A distance from the position A₂ to the position Be in the width direction y is, for example, preferably equal to or greater than about 5 μm and equal to or less than about 20 μm. Accordingly, the distance from the position A₂ to the position Be can be made sufficient, and therefore the direction of the compressive stress can be sufficiently changed. On the other hand, in a case where the distance from the position A₂ to the position Be in the width direction y is less than about 5 μm, the end edge portion P₁₃ of the first thin film layer 726a that is located adjacent to the center of the multilayer body 512 in the width direction y cannot be sufficiently spaced apart from the multilayer body 512. In a case where the distance from the position A₂ to the position Be in the width direction y is larger than about 20 μm, a crack may undesirably occur in the multilayer body 512 due to excessive stress of the first thin film layer 726a.

Similarly, an end edge portion P₁₄ of the second thin film layer 726b that is located adjacent to the center of the multilayer body 512 in the width direction y is spaced apart from the multilayer body 512 in the laminating direction x. That is, the end edge portion P₁₄ of the second thin film layer 726b that is located adjacent to the center of the multilayer body 512 in the width direction y is floating above the multilayer body 512.

An end edge portion Piz of the third thin film layer 727a that is located adjacent to the center of the multilayer body 512 in the width direction y is spaced apart from the multilayer body 512 in the laminating direction x. That is, the end edge portion P₁₇ of the third thin film layer 727a that is located adjacent to the center of the multilayer body 512 in the width direction y is floating above the multilayer body 512.

An end edge portion P₁₈ of the fourth thin film layer 727b that is located adjacent to the center of the multilayer body 512 in the width direction y is spaced apart from the multilayer body 512 in the laminating direction x. That is, the end edge portion P₁₈ of the fourth thin film layer 727b that is located adjacent to the center of the multilayer body 512 in the width direction y is floating above the multilayer body 512.

As for the second thin film layer 726b, the third thin film layer 727a, and the fourth thin film layer 727b, the end edge portions P₁₄, P₁₇, and P₁₈ are continuously floating in the length direction z, and therefore tensile stress applied to the end edge portions P₁₄, P₁₇, and P₁₈ can be maintained small even upon application of thermal stress, as with the first thin film layer 726a. This can reduce or prevent the occurrence of a crack in the multilayer body 512 caused by thermal stress.

In the present example embodiment, the first thin film layer 726a, the second thin film layer 726b, the third thin film layer 727a, and the fourth thin film layer 727b are disposed only on the first main surface 512a. However, the first thin film layer 726a, the second thin film layer 726b, the third thin film layer 727a, and the fourth thin film layer 727b may be disposed not only on the first main surface 512a, but also on the first side surface 512c, the second side surface 512d, the third side surface 512e, and the fourth side surface 512f. In a case where the thin film layers 726 and 727 are disposed in this way, end edge portions that are located adjacent to the center of the multilayer body 512 in the length direction z and/or the width direction y among end edge portions of the first thin film layer 726a, the second thin film layer 726b, the third thin film layer 727a, and the fourth thin film layer 727b that are disposed on the first side surface 512c, the second side surface 512d, the third side surface 512e, and the fourth side surface 512f may be spaced apart from the multilayer body 512, as described in the third example embodiment.

A lower plating layer 728 includes a first lower plating layer 728a and a second lower plating layer 728b. A lower plating layer 729 includes a third lower plating layer 729a and a fourth lower plating layer 729b. The lower plating layers 728 and 729 are disposed on the thin film layers 726 and 727 and on the first side surface 512c, the second side surface 512d, the third side surface 512e, and the fourth side surface 512f. The lower plating layers 728 and 729 are provided so as to be in between the multilayer body 512 and the thin film layers 726 and 727.

The first lower plating layer 728a is disposed on the first side surface 512c and the third side surface 512e of the multilayer body 512 on which the first thin film layer 726a is not disposed and covers the first thin film layer 726a disposed on the first main surface 512a.

The second lower plating layer 728b is disposed on the second side surface 512d and the fourth side surface 512f of the multilayer body 512 on which the second thin film layer 726b is not disposed and covers the second thin film layer 726b disposed on the first main surface 512a.

The third lower plating layer 729a is disposed on the first side surface 512c and the fourth side surface 512f of the multilayer body 512 on which the third thin film layer 727a is not disposed and covers the third thin film layer 727a disposed on the first main surface 512a.

The fourth lower plating layer 729b is disposed on the second side surface 512d and the third side surface 512e of the multilayer body 512 on which the fourth thin film layer 727b is not disposed and covers the fourth thin film layer 727b disposed on the first main surface 512a.

An upper plating layer 730 includes a first upper plating layer 730a and a second upper plating layer 730b. An upper plating layer 731 includes a third upper plating layer 731a and a fourth upper plating layer 731b. The first upper plating layer 730a covers the first lower plating layer 728a. The second upper plating layer 730b covers the second lower plating layer 728b. The third upper plating layer 731a covers the third lower plating layer 729a. The fourth upper plating layer 731b covers the fourth lower plating layer 729b.

A front plating layer 732 includes a first front plating layer 732a and a second front plating layer 732b. A front plating layer 733 includes a third front plating layer 733a and a fourth front plating layer 733b. The first front plating layer 732a covers the first upper plating layer 730a. The second front plating layer 732b covers the second upper plating layer 730b. The third front plating layer 733a covers the third upper plating layer 731a. The fourth front plating layer 733b covers the fourth upper plating layer 731b.

For example, although only shapes that are symmetrical or substantially symmetrical in front view are illustrated in the above example embodiments, an external shape of a multilayer ceramic capacitor according to an example embodiment of the present invention can be changed in various ways in accordance with a target on which the multilayer ceramic capacitor is mounted and in accordance with required performance. The present invention encompasses appropriate combinations of all or some of the configurations of the above example embodiments.

That is, the example embodiments described above may be changed in various ways regarding a mechanism, a shape, a material, a quantity, a position, a layout, or the like without departing from the technical idea and the scope of the present invention, and these changes are encompassed within the present invention.

Example embodiments of the present invention relate to multilayer ceramic capacitors, and can be used, for example, as multilayer ceramic capacitors including an outer electrode including a thin film layer.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first main surface and a second main surface opposed to each other in a laminating direction, a first side surface and a second side surface opposed to each other in a width direction orthogonal or substantially orthogonal to the laminating direction, a first end surface and a second end surface opposed to each other in a length direction orthogonal or substantially orthogonal to the laminating direction and the width direction, a first internal electrode layer exposed on the first end surface;
a first outer electrode covering a portion of the first end surface and a portion of the first main surface of the multilayer body; and
a second outer electrode covering a portion of the second end surface and a portion of the first main surface of the multilayer body; wherein
the first outer electrode and the second outer electrode each include:
a thin film layer covering at least a portion of the first main surface;
a plating layer covering at least a portion of the thin film layer; wherein
an end edge portion of the thin film layer located adjacent to a center of the multilayer body is spaced apart from the multilayer body on the first main surface.

2. The multilayer ceramic capacitor according to claim 1, wherein the multilayer ceramic capacitor has a dimension in the length direction larger than a dimension in the width direction.

3. The multilayer ceramic capacitor according to claim 1, wherein the multilayer ceramic capacitor has a dimension in the width direction larger than a dimension in the length direction.

4. The multilayer ceramic capacitor according to claim 1, wherein
a ratio of a dimension of the multilayer ceramic capacitor in the width direction to a dimension of the multilayer ceramic capacitor in the length direction is about 7/10 or more and about 10/7 or less;
a third outer electrode covers a portion of the first main surface and at least a portion of the first side surface of the multilayer body; and
a fourth outer electrode covers a portion of the first main surface and at least a portion of the third side surface of the multilayer body.

5. The multilayer ceramic capacitor according to claim 2, wherein ∠ABC is equal to or greater than about 20 degrees and equal to or less than about 70 degrees, where A, B, and C are positions of an end edge portion of the thin film layer located adjacent to a center of the multilayer body in the length direction, and the position A is a position of the thin film layer that is closest to the center of the multilayer body in the length direction, the position B is a position at which the thin film layer starts to be spaced apart from the multilayer body in the laminating direction, and the position C is a position at which a perpendicular of substantially perpendicular extending from the position A in the laminating direction crosses the multilayer body.

6. The multilayer ceramic capacitor according to claim 3, wherein ∠ABC is equal to or greater than about 20 degrees and equal to or less than about 70 degrees, where A, B, and C are positions of an end edge portion of the thin film layer located adjacent to a center of the multilayer body in the length direction, and the position A is a position of the thin film layer that is closest to the center of the multilayer body in the length direction, the position B is a position at which the thin film layer starts to be spaced apart from the multilayer body in the laminating direction, and the position C is a position at which a perpendicular of substantially perpendicular extending from the position A in the laminating direction crosses the multilayer body.

7. The multilayer ceramic capacitor according to claim 4, wherein ∠ABC is equal to or greater than about 20 degrees and equal to or less than about 70 degrees, where A, B, and C are positions of an end edge portion of the thin film layer located adjacent to a center of the multilayer body in the length direction, and the position A is a position of the thin film layer that is closest to the center of the multilayer body in the length direction, the position B is a position at which the thin film layer starts to be spaced apart from the multilayer body in the laminating direction, and the position C is a position at which a perpendicular of substantially perpendicular extending from the position A in the laminating direction crosses the multilayer body.

8. The multilayer ceramic capacitor according to claim 7, wherein ∠DEF is equal to or greater than about 20 degrees and equal to or less than about 70 degrees, where D, E, and F are positions of an end edge portion of the thin film layer located adjacent to a center of the multilayer body in the width direction, and the position D is a position of the thin film layer that is closest to the center of the multilayer body in the width direction, the position E is a position at which the thin film layer starts to be spaced apart from the multilayer body in the laminating direction, and the position F is a position at which a perpendicular of substantially perpendicular extending from the position E in the laminating direction crosses the multilayer body.

9. The multilayer ceramic capacitor according to claim 2, wherein a distance from a position A to a position B in the length direction is equal to or greater than about 5 μm and equal to or less than about 20 μm, where the position A and the position B are positions of an end edge portion of the thin film layer that is located adjacent to a center of the multilayer body in the length direction, and the position A is a position of the thin film layer that is closest to the center of the multilayer body in the length direction and the position B is a position at which the thin film layer starts to be spaced apart from the multilayer body in the laminating direction.

10. The multilayer ceramic capacitor according to claim 3, wherein a distance from a position A to a position B in the length direction is equal to or greater than about 5 μm and equal to or less than about 20 μm, where the position A and the position B are positions of an end edge portion of the thin film layer that is located adjacent to a center of the multilayer body in the length direction, and the position A is a position of the thin film layer that is closest to the center of the multilayer body in the length direction and the position B is a position at which the thin film layer starts to be spaced apart from the multilayer body in the laminating direction.

11. The multilayer ceramic capacitor according to claim 4, wherein a distance from a position A to a position B in the length direction is equal to or greater than about 5 μm and equal to or less than about 20 μm, where the position A and the position B are positions of an end edge portion of the thin film layer that is located adjacent to a center of the multilayer body in the length direction, and the position A is a position of the thin film layer that is closest to the center of the multilayer body in the length direction and the position B is a position at which the thin film layer starts to be spaced apart from the multilayer body in the laminating direction.

12. The multilayer ceramic capacitor according to claim 11, wherein a distance from a position C to a position D in the width direction is equal to or greater than about 5 μm and equal to or less than about 20 μm, where the position C and the position D are positions of an end edge portion of the thin film layer that is located adjacent to a center of the multilayer body in the width direction, and the position C is a position of the thin film layer that is closest to the center of the multilayer body in the width direction and the position D is a position at which the thin film layer starts to be spaced apart from the multilayer body in the laminating direction.

13. A multilayer ceramic capacitor comprising:
a multilayer body including a first main surface and a second main surface opposed to each other in a laminating direction, a first side surface and a second side surface opposed to each other in a width direction orthogonal or substantially orthogonal to the laminating direction, a third side surface and a fourth side surface opposed to each other in a length direction orthogonal or substantially orthogonal to the laminating direction and the width direction, a first internal electrode layer exposed at least on the first side surface and the second side surface, and a second internal electrode layer exposed at least on the first side surface and the second side surface;
a first outer electrode covering a portion of the first side surface and a portion of the first main surface of the multilayer body;
a second outer electrode covering a portion of the second side surface and a portion of the first main surface of the multilayer body;
a third outer electrode spaced apart from the first outer electrode and covering a portion of the first side surface and a portion of the first main surface of the multilayer body; and
a fourth outer electrode spaced apart from the second outer electrode and covering a portion of the second side surface and a portion of the first main surface of the multilayer body;
wherein
the first outer electrode and the third outer electrode each include:
a thin film layer covering at least a portion of the first side surface of the multilayer body;
a plating layer covering at least a portion of the thin film layer; and
an end edge portion of the thin film layer located adjacent to a center of the multilayer body is spaced apart from the multilayer body.

14. The multilayer ceramic capacitor according to claim 13, wherein at least one of end edge portions of the thin film layer that face each other in the length direction among end edge portions of the thin film layer located adjacent to the center of the multilayer body is spaced apart from the multilayer body.

15. The multilayer ceramic capacitor according to claim 14, wherein ∠A₃B₃C₃ is equal to or greater than about 20 degrees and equal to or less than about 70 degrees, where A₃, B₃, and C₃ are positions of an end edge portion of the thin film layer on the first side surface located adjacent to a center of the multilayer body in the length direction, and the position A₃ is a position of the thin film layer that is closest to the center of the multilayer body in the length direction, the position B₃ is a position at which the thin film layer starts to be spaced apart from the multilayer body in the width direction, and the position C₃ is a position at which a perpendicular or substantially perpendicular line extending from the position A₃ in the width direction crosses the multilayer body.

16. The multilayer ceramic capacitor according to claim 14, wherein a distance from a position A₃ to a position B₃ in the length direction is equal to or greater than about 5 μm and equal to or less than about 20 μm, where the position A₃ and the position B₃ are positions of an end edge portion of the thin film layer on the first side surface located adjacent to a center of the multilayer body in the length direction, and the position A₃ is a position of the thin film layer that is closest to the center of the multilayer body in the length direction and the position B₃ is a position at which the thin film layer starts to be spaced apart from the multilayer body in the width direction.
